(19) United States
(12) Patent Application Publication
(10) Pub. No.: US 2020/0216064 A1
(43) Pub. Date: Jul. 9, 2020

(54) CLASSIFYING PERCEIVED OBJECTS BASED ON ACTIVITY

(71) Applicant: Aptiv Technologies Limited, St. Michael (SG)

(72) Inventors: Philip Christopher du Toit, Singapore (SG); Emilio Frazzoli, Newton, MA (US); Baoxing Qin, Singapore (SG); Yawei Ye, Singapore (SG)

(21) Appl. No.: 16/736,929

(22) Filed: Jan. 8, 2020

Related U.S. Application Data
(60) Provisional application No. 62/789,804, filed on Jan. 8, 2019.

(30) Foreign Application Priority Data
Mar. 1, 2019 (DK) PA201970146

(51) Int. Cl. B60W 30/095; B60W 30/09; B60W 30/18; G05D 1/02; G06N 20/00

(52) U.S. Cl. CPC B60W 30/0956; B60W 30/09; G06N 20/00; G05D 1/0238; G05D 1/0221; B60W 30/18163

(57) ABSTRACT

Among other things, systems and methods for classifying perceived objects based on activity are disclosed. The systems and methods can include means for receiving sensor information corresponding to at least one object and determining an activity prediction for the at least one object in accordance with the sensor information. The system and methods can include means for classifying the object in accordance with the activity prediction. A controller circuit can operate control functions of a vehicle at least partially based on the classification of the at least one object.

### CROSS-REFERENCE TO RELATED APPLICATION

This application claims the benefit of U.S. Provisional Application 62/789,804, filed on Jan. 8, 2019, and Denmark Application PA-2019-70146, filed on Mar. 1, 2019, both of which are incorporated herein by reference in their entirety.

### FIELD OF THE INVENTION

This disclosure generally relates to classifying objects. In particular, this disclosure relates to classifying perceived objects based on activity.

### BACKGROUND

Autonomous vehicles, e.g., drones and self-driving cars, can be configured to autonomously navigate throughout an environment. These vehicles may rely on sensors of various types to detect their surrounding environment. For example, an autonomous vehicle can include LiDAR sensors, radar sensors, stereo cameras, infrared cameras, and so forth. These sensors may be an important feature that allows the vehicle to avoid damaging surrounding pedestrians, structures and/or the vehicle itself.

### SUMMARY

In at least one aspect of the present disclosure a vehicle is provided. The vehicle includes at least one sensor configured to receive sensor information corresponding to at least one object proximate to the vehicle. The vehicle includes at least one controller circuit configured to operate control functions of the vehicle. The vehicle includes a computer-readable medium storing computer-executable instructions. The vehicle includes at least one processor communicatively coupled to the at least one sensor and configured to execute the computer-executable instructions to receive the sensor information from the at least one sensor, determine an activity prediction for the at least one object in accordance with the sensor information, classify the at least one object in accordance with the activity prediction; and cause the controller circuit to operate the control functions of the vehicle at least partially based on the classification of the at least one object.

The at least one processor can include a Bayesian model processor. The at least one processor can include a deep learning processor. The deep learning processor can include at least one of: a feed-forward neural network, a convolutional neural network, a radial basis function neural network, a recurrent neural network, or a modular neural network.

Classifying the at least one object can include determining likelihood that the at least one object is inactive or active. Determining that the at least one object is active can include determining whether the at least one object will be in motion for a predetermined time interval. Determining that the at least one object is inactive can include determining whether the at least one object will remain static for a predetermined time interval. Classifying the at least one object can include assigning an overtake value.

Operating the control functions of the vehicle can include causing the vehicle to travel at a predicted speed, wherein the predicted speed is based at least partially on learned human-like behavior. Operating the control functions of the vehicle can include causing the vehicle to travel at a predicted speed. The predicted speed can be based at least partially on at least one of: sensor data, historical speed data of the vehicle, position data of the vehicle, current position data of the at least one object, historical position data of the at least one object and traffic light data. Operating the control functions of the vehicle can include causing the vehicle to overtake the at least one object when the at least one processor classifies the at least one object as inactive. Causing the controller circuit to operate the control functions of the vehicle can be at least partially based on at least one road rule. Operating the control functions of the vehicle can include causing the vehicle to approach the at least one object at a predetermined speed. Operating the control functions of the vehicle can include causing the vehicle to maintain a predetermined distance from the at least one object. When the vehicle is traversing a primary route, operating the control functions of the vehicle can include causing the vehicle to traverse an alternate route.

The at least one processor can be configured to determine one or more attributes of the at least one object based on the received sensor information. Causing the controller circuit to operate the control functions of the vehicle can be at least partially based on the determined one or more attributes. The one or more attributes can include at least one of: a road lane in which the at least one object is located, a distance to a traffic sign of the at least one object, a distance to a designated parking space of the at least one object, or the speed of the at least one object.

The at least one processor can further carry out operations to assign a weight to the determined one or more attributes of the at least one object. The at least one processor can further be configured to cause the controller circuit to operate the control functions of the vehicle is at least partially based on the assigned weight. The at least one processor can further carry out operations to continuously update the assigned weight based on feedback information.

The at least one processor can further carry out operations to generate an uncertainty value corresponding to the classifying of the at least one object. The at least one processor can further be configured to carry out operations to cause the controller circuit to operate the control functions of the vehicle to cause the vehicle to at least one of: stop or slow down when the uncertainty value meets an uncertainty value threshold, and cause the at least one sensor to capture additional sensor information corresponding to the least one object.

In at least one other aspect of the present disclosure, a method is provided. The method includes detecting, by at least one sensor, sensor information corresponding to at least one object proximate to a vehicle. The method includes receiving the sensor information from the at least one sensor. The method includes determining an activity prediction for the at least one object in accordance with the sensor information. The method includes classifying the at least one object in accordance with the activity prediction. The method includes operating control functions of the vehicle at least partially based on the classification of the at least one object.

### BRIEF DESCRIPTION OF THE DRAWINGS

FIG. 1 shows an example of an autonomous vehicle having autonomous capability.

FIG. 2 illustrates an example “cloud” computing environment.

FIG. 3 illustrates a computer system.

FIG. 4 shows an example architecture for an autonomous vehicle.

FIG. 5 shows an example of inputs and outputs that may be used by a perception module.

FIG. 6 shows an example of a LiDAR system.

FIG. 7 shows the LiDAR system in operation.

FIG. 8 shows the operation of the LiDAR system in additional detail.

FIG. 9 shows a block diagram of the relationships between inputs and outputs of a planning module.

FIG. 10 shows a directed graph used in path planning.

FIG. 11 shows a block diagram of the inputs and outputs of a control module.

FIG. 12 shows a block diagram of the inputs, outputs, and components of a controller.

FIG. 13 is an illustrative example showing an environment including a vehicle having a system for classifying one or more perceived objects based on activity, according to one or more embodiments of the present disclosure.

FIG. 14 shows an environment in which an AV overtakes a target vehicle based on the classification of the target vehicle, according to one or more embodiments of the present disclosure.

FIG. 15 shows a method for classifying perceived objects based on activity, according to one or more embodiments of the present disclosure.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

In the drawings, specific arrangements or orderings of schematic elements, such as those representing devices, modules, instruction blocks and data elements, are shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

Further, in the drawings, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the disclosure. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths (e.g., a bus), as may be needed, to affect the communication.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Several features are described hereafter that can each be used independently of one another or with any combination of other features. However, any individual feature may not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in this description. Embodiments are described herein according to the following outline:
1. General Overview
2. Hardware Overview
3. Autonomous Vehicle Architecture
4. Autonomous Vehicle Inputs
5. Autonomous Vehicle Planning
6. Autonomous Vehicle Control

### General Overview

Although sensors can be important tools for an AV to navigate the surrounding environment, conventional AV systems may not use this information in such a manner to allow the AV to replicate typical human driving behavior that involves making subjective decisions. For example, while a traditional AV system can use sensors to avoid detected objects/pedestrians, traditional AV systems may not have the capabilities of using the sensor information to determine whether or not to pass a vehicle on the road. Being able to make such determinations may be important with respect to safety and traffic flow considerations.

The present disclosure provides systems and methods for classifying perceived objects based on activity. The systems and methods can be integrated with an AV to provide the AV with the ability to determine if a perceived object is active/inactive based on information captured by its sensors. Based on this determination, the AV can determine if it should maneuver around the perceived object.

### System Overview

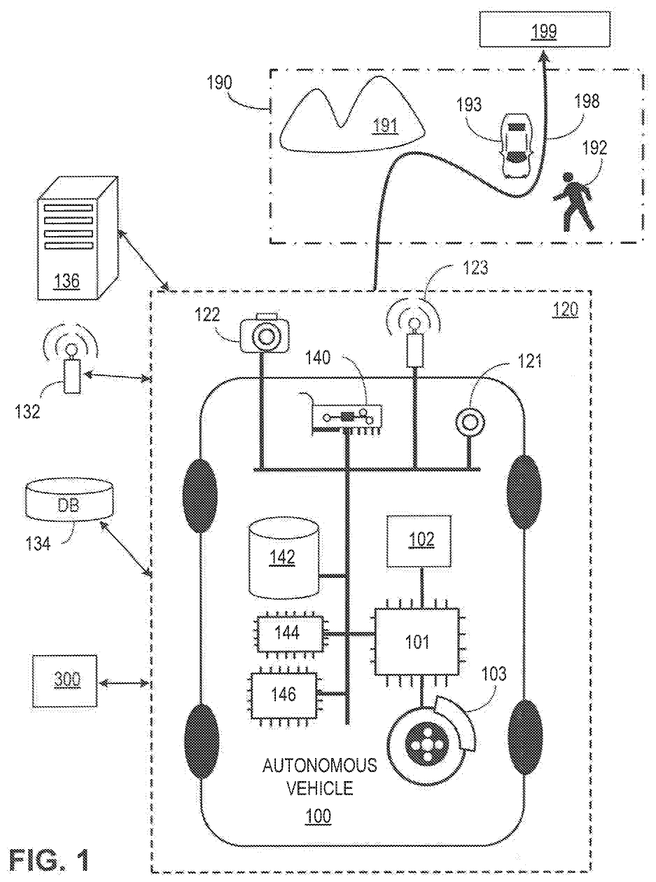

FIG. 1 shows an example of an autonomous vehicle 100 having autonomous capability.

As used herein, the term “autonomous capability” refers to a function, feature, or facility that enables a vehicle to be partially or fully operated without real-time human intervention, including without limitation fully autonomous vehicles, highly autonomous vehicles, and conditionally autonomous vehicles.

As used herein, an autonomous vehicle (AV) is a vehicle that possesses autonomous capability.

As used herein, “vehicle” includes means of transportation of goods or people. For example, cars, buses, trains, airplanes, drones, trucks, boats, ships, submersibles, dirigibles, etc. A driverless car is an example of a vehicle.

As used herein, “trajectory” refers to a path or route to navigate an AV from a first spatiotemporal location to second spatiotemporal location. In an embodiment, the first spatiotemporal location is referred to as the initial or starting location and the second spatiotemporal location is referred to as the destination, final location, goal, goal position, or goal location. In some examples, a trajectory is made up of one or more segments (e.g., sections of road) and each segment is made up of one or more blocks (e.g., portions of a lane or intersection). In an embodiment, the spatiotemporal locations correspond to real world locations. For example, the spatiotemporal locations are pick up or drop-off locations to pick up or drop-off persons or goods.

As used herein, “sensor(s)” includes one or more hardware components that detect information about the environment surrounding the sensor. Some of the hardware components can include sensing components (e.g., image sensors, biometric sensors), transmitting and/or receiving components (e.g., laser or radio frequency wave transmitters and receivers), electronic components such as analog-to-digital converters, a data storage device (such as a RAM and/or a nonvolatile storage), software or firmware components and data processing components such as an ASIC (application-specific integrated circuit), a microprocessor and/or a microcontroller.

As used herein, a “scene description” is a data structure (e.g., list) or data stream that includes one or more classified or labeled objects detected by one or more sensors on the AV vehicle or provided by a source external to the AV.

As used herein, a “road” is a physical area that can be traversed by a vehicle, and may correspond to a named thoroughfare (e.g., city street, interstate freeway, etc.) or may correspond to an unnamed thoroughfare (e.g., a driveway in a house or office building, a section of a parking lot, a section of a vacant lot, a dirt path in a rural area, etc.). Because some vehicles (e.g., 4-wheel-drive pickup trucks, sport utility vehicles, etc.) are capable of traversing a variety of physical areas not specifically adapted for vehicle travel, a “road” may be a physical area not formally defined as a thoroughfare by any municipality or other governmental or administrative body.

As used herein, a “lane” is a portion of a road that can be traversed by a vehicle. A lane is sometimes identified based on lane markings. For example, a lane may correspond to most or all of the space between lane markings, or may correspond to only some (e.g., less than 50%) of the space between lane markings. For example, a road having lane markings spaced far apart might accommodate two or more vehicles between the markings, such that one vehicle can pass the other without traversing the lane markings, and thus could be interpreted as having a lane narrower than the space between the lane markings, or having two lanes between the lane markings. A lane could also be interpreted in the absence of lane markings. For example, a lane may be defined based on physical features of an environment, e.g., rocks and trees along a thoroughfare in a rural area or, e.g., natural obstructions to be avoided in an undeveloped area. A lane could also be interpreted independent of lane markings or physical features. For example, a lane could be interpreted based on an arbitrary path free of obstructions in an area that otherwise lacks features that would be interpreted as lane boundaries. In an example scenario, an AV could interpret a lane through an obstruction-free portion of a field or empty lot. In another example scenario, an AV could interpret a lane through a wide (e.g., wide enough for two or more lanes) road that does not have lane markings. In this scenario, the AV could communicate information about the lane to other AVs so that the other AVs can use the same lane information to coordinate path planning among themselves.

The term “over-the-air (OTA) client” includes any AV, or any electronic device (e.g., computer, controller, IoT device, electronic control unit (ECU)) that is embedded in, coupled to, or in communication with an AV.

The term “over-the-air (OTA) update” means any update, change, deletion or addition to software, firmware, data or configuration settings, or any combination thereof, that is delivered to an OTA client using proprietary and/or standardized wireless communications technology, including but not limited to: cellular mobile communications (e.g., 2G, 3G, 4G, 5G), radio wireless area networks (e.g., WiFi) and/or satellite Internet.

The term “edge node” means one or more edge devices coupled to a network that provide a portal for communication with AVs and can communicate with other edge nodes and a cloud based computing platform, for scheduling and delivering OTA updates to OTA clients.

The term “edge device” means a device that implements an edge node and provides a physical wireless access point (AP) into enterprise or service provider (e.g., VERIZON, AT&T) core networks. Examples of edge devices include but are not limited to: computers, controllers, transmitters, routers, routing switches, integrated access devices (IADs), multiplexers, metropolitan area network (MAN) and wide area network (WAN) access devices.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

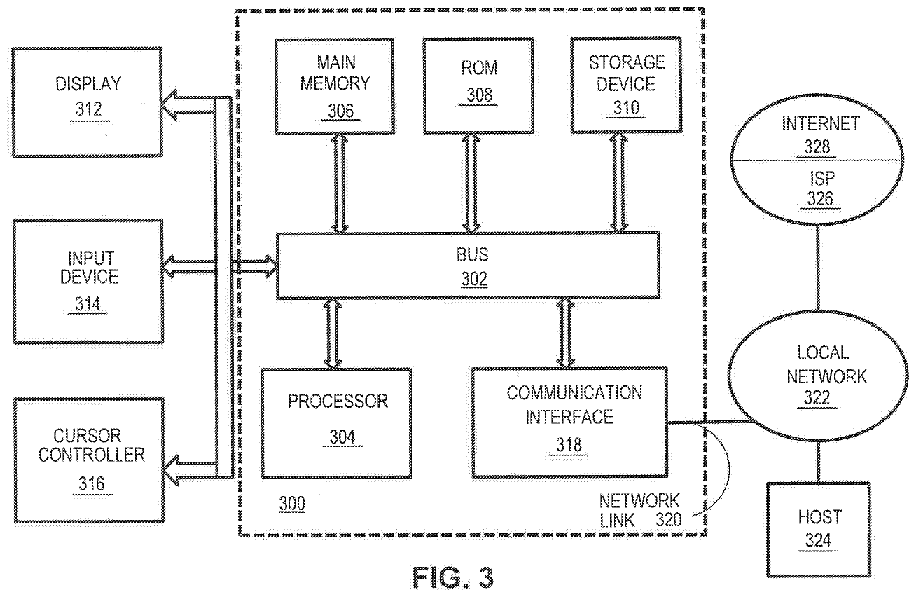

As used herein, an AV system refers to the AV along with the array of hardware, software, stored data, and data generated in real-time that supports the operation of the AV. In an embodiment, the AV system is incorporated within the AV. In an embodiment, the AV system is spread across several locations. For example, some of the software of the AV system is implemented on a cloud computing environment similar to cloud computing environment 300 described below with respect to FIG. 3.

In general, this document describes technologies applicable to any vehicles that have one or more autonomous capabilities including fully autonomous vehicles, highly autonomous vehicles, and conditionally autonomous vehicles, such as so-called Level 5, Level 4 and Level 3 vehicles, respectively (see SAE International's standard J3016: Taxonomy and Definitions for Terms Related to On-Road Motor Vehicle Automated Driving Systems, which is incorporated by reference in its entirety, for more details on the classification of levels of autonomy in vehicles). The technologies described in this document are also applicable to partially autonomous vehicles and driver assisted vehicles, such as so-called Level 2 and Level 1 vehicles (see SAE International's standard J3016: Taxonomy and Definitions for Terms Related to On-Road Motor Vehicle Automated Driving Systems). In an embodiment, one or more of the Level 1, 2, 3, 4 and 5 vehicle systems may automate certain vehicle operations (e.g., steering, braking, and using maps) under certain operating conditions based on processing of sensor inputs. The technologies described in this document can benefit vehicles in any levels, ranging from fully autonomous vehicles to human-operated vehicles.

Autonomous vehicles have advantages over vehicles that require a human driver. One advantage is safety. For example, in 2016, the United States experienced 6 million automobile accidents, 2.4 million injuries, 40,000 fatalities, and 13 million vehicles in crashes, estimated at a societal cost of $910+ billion. U.S. traffic fatalities per 100 million miles traveled have been reduced from about six to about one from 1965 to 2015, in part due to additional safety measures deployed in vehicles. For example, an additional half second of warning that a crash is about to occur is believed to mitigate 60% of front-to-rear crashes. However, passive safety features (e.g., seat belts, airbags) have likely reached their limit in improving this number. Thus, active safety measures, such as automated control of a vehicle, are the likely next step in improving these statistics. Because human drivers are believed to be responsible for a critical pre-crash event in 95% of crashes, automated driving systems are likely to achieve better safety outcomes, e.g., by reliably recognizing and avoiding critical situations better than humans; making better decisions, obeying traffic laws, and predicting future events better than humans; and reliably controlling a vehicle better than a human.

Referring to FIG. 1, an AV system 120 operates the AV 100 along a trajectory 198 through an environment 190 to a destination 199 (sometimes referred to as a final location) while avoiding objects (e.g., natural obstructions 191, vehicles 193, pedestrians 192, cyclists, and other obstacles) and obeying rules of the road (e.g., rules of operation or driving preferences).

In an embodiment, the AV system 120 includes devices 101 that are instrumented to receive and act on operational commands from the computer processors 146. In an embodiment, computing processors 146 are similar to the processor 304 described below in reference to FIG. 3. Examples of devices 101 include a steering control 102, brakes 103, gears, accelerator pedal or other acceleration control mechanisms, windshield wipers, side-door locks, window controls, and turn-indicators.

In an embodiment, the AV system 120 includes sensors 121 for measuring or inferring properties of state or condition of the AV 100, such as the AV's position, linear and angular velocity and acceleration, and heading (e.g., an orientation of the leading end of AV 100). Example of sensors 121 are GPS, inertial measurement units (IMU) that measure both vehicle linear accelerations and angular rates, wheel speed sensors for measuring or estimating wheel slip ratios, wheel brake pressure or braking torque sensors, engine torque or wheel torque sensors, and steering angle and angular rate sensors.

In an embodiment, the sensors 121 also include sensors for sensing or measuring properties of the AV's environment. For example, monocular or stereo video cameras 122 in the visible light, infrared or thermal (or both) spectra, LiDAR 123, RADAR, ultrasonic sensors, time-of-flight (TOF) depth sensors, speed sensors, temperature sensors, humidity sensors, and precipitation sensors.

In an embodiment, the AV system 120 includes a data storage unit 142 and memory 144 for storing machine instructions associated with computer processors 146 or data collected by sensors 121. In an embodiment, the data storage unit 142 is similar to the ROM 308 or storage device 310 described below in relation to FIG. 3. In an embodiment, memory 144 is similar to the main memory 306 described below. In an embodiment, the data storage unit 142 and memory 144 store historical, real-time, and/or predictive information about the environment 190. In an embodiment, the stored information includes maps, driving performance, traffic congestion updates or weather conditions. In an embodiment, data relating to the environment 190 is transmitted to the AV 100 via a communications channel from a remotely located database 134.

In an embodiment, the AV system 120 includes communications devices 140 for communicating measured or inferred properties of other vehicles' states and conditions, such as positions, linear and angular velocities, linear and angular accelerations, and linear and angular headings to the AV 100. These devices include Vehicle-to-Vehicle (V2V) and Vehicle-to-Infrastructure (V2I) communication devices and devices for wireless communications over point-to-point or ad hoc networks or both. In an embodiment, the communications devices 140 communicate across the electromagnetic spectrum (including radio and optical communications) or other media (e.g., air and acoustic media). A combination of Vehicle-to-Vehicle (V2V) Vehicle-to-Infrastructure (V2I) communication (and, in some embodiments, one or more other types of communication) is sometimes referred to as Vehicle-to-Everything (V2X) communication. V2X communication typically conforms to one or more communications standards for communication with, between, and among autonomous vehicles.

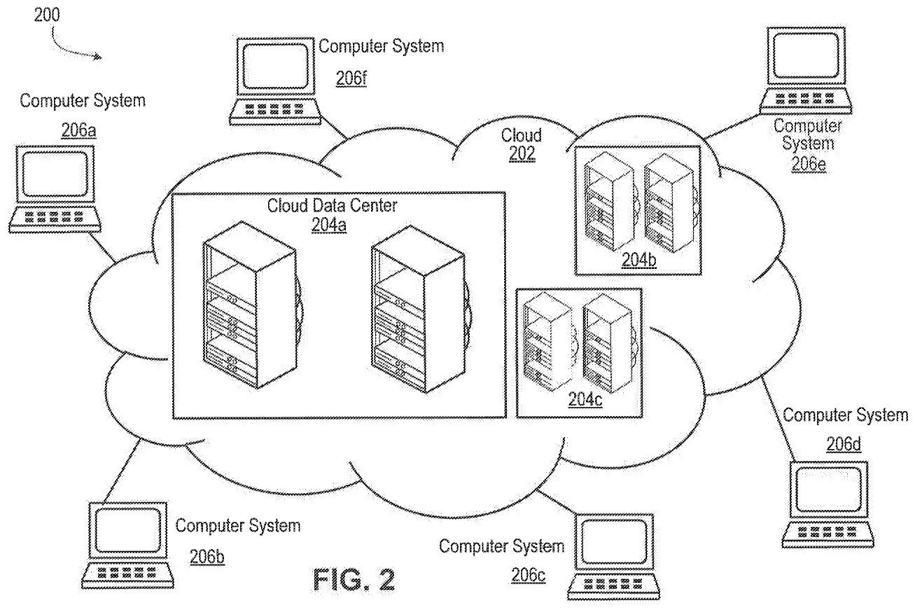

In an embodiment, the communication devices 140 include communication interfaces. For example, wired, wireless, WiMAX, Wi-Fi, Bluetooth, satellite, cellular, optical, near field, infrared, or radio interfaces. The communication interfaces transmit data from a remotely located database 134 to AV system 120. In an embodiment, the remotely located database 134 is embedded in a cloud computing environment 200 as described in FIG. 2. The communication interfaces 140 transmit data collected from sensors 121 or other data related to the operation of AV 100 to the remotely located database 134. In an embodiment, communication interfaces 140 transmit information that relates to teleoperations to the AV 100. In some embodiments, the AV 100 communicates with other remote (e.g., “cloud”) servers 136.

In an embodiment, the remotely located database 134 also stores and transmits digital data (e.g., storing data such as road and street locations). Such data is stored on the memory 144 on the AV 100, or transmitted to the AV 100 via a communications channel from the remotely located database 134.

In an embodiment, the remotely located database 134 stores and transmits historical information about driving properties (e.g., speed and acceleration profiles) of vehicles that have previously traveled along trajectory 198 at similar times of day. In one implementation, such data may be stored on the memory 144 on the AV 100, or transmitted to the AV 100 via a communications channel from the remotely located database 134.

Computing devices 146 located on the AV 100 algorithmically generate control actions based on both real-time sensor data and prior information, allowing the AV system 120 to execute its autonomous driving capabilities.

In an embodiment, the AV system 120 includes computer peripherals 132 coupled to computing devices 146 for providing information and alerts to, and receiving input from, a user (e.g., an occupant or a remote user) of the AV 100. In an embodiment, peripherals 132 are similar to the display 312, input device 314, and cursor controller 316 discussed below in reference to FIG. 3. The coupling is wireless or wired. Any two or more of the interface devices may be integrated into a single device.

FIG. 2 illustrates an example “cloud” computing environment. Cloud computing is a model of service delivery for enabling convenient, on-demand network access to a shared pool of configurable computing resources (e.g. networks, network bandwidth, servers, processing, memory, storage, applications, virtual machines, and services). In typical cloud computing systems, one or more large cloud data centers house the machines used to deliver the services provided by the cloud. Referring now to FIG. 2, the cloud computing environment 200 includes cloud data centers 204a, 204b, and 204c that are interconnected through the cloud 202. Data centers 204a, 204b, and 204c provide cloud computing services to computer systems 206a, 206b, 206c, 206d, 206e, and 206f connected to cloud 202.

The cloud computing environment 200 includes one or more cloud data centers. In general, a cloud data center, for example the cloud data center 204a shown in FIG. 2, refers to the physical arrangement of servers that make up a cloud, for example the cloud 202 shown in FIG. 2, or a particular portion of a cloud. For example, servers are physically arranged in the cloud datacenter into rooms, groups, rows, and racks. A cloud datacenter has one or more zones, which include one or more rooms of servers. Each room has one or more rows of servers, and each row includes one or more racks. Each rack includes one or more individual server nodes. In some implementation, servers in zones, rooms, racks, and/or rows are arranged into groups based on physical infrastructure requirements of the datacenter facility, which include power, energy, thermal, heat, and/or other requirements. In an embodiment, the server nodes are similar to the computer system described in FIG. 3. The data center 204a has many computing systems distributed through many racks.

The cloud 202 includes cloud data centers 204a, 204b, and 204c along with the network and networking resources (for example, networking equipment, nodes, routers, switches, and networking cables) that interconnect the cloud data centers 204a, 204b, and 204c and help facilitate the computing systems' 206a-f access to cloud computing services. In an embodiment, the network represents any combination of one or more local networks, wide area networks, or internetworks coupled using wired or wireless links deployed using terrestrial or satellite connections. Data exchanged over the network, is transferred using any number of network layer protocols, such as Internet Protocol (IP), Multiprotocol Label Switching (MPLS), Asynchronous Transfer Mode (ATM), Frame Relay, etc. Furthermore, in embodiments where the network represents a combination of multiple sub-networks, different network layer protocols are used at each of the underlying sub-networks. In some embodiments, the network represents one or more interconnected internetworks, such as the public Internet.

The computing systems 206a-f or cloud computing services consumers are connected to the cloud 202 through network links and network adapters. In an embodiment, the computing systems 206a-f are implemented as various computing devices, for example servers, desktops, laptops, tablet, smartphones, Internet of Things (IoT) devices, autonomous vehicles (including, cars, drones, shuttles, trains, buses, etc.) and consumer electronics. In an embodiment, the computing systems 206a-f are implemented in or as a part of other systems.

FIG. 3 illustrates a computer system 300. In an implementation, the computer system 300 is a special purpose computing device. The special-purpose computing device is hard-wired to perform the techniques or includes digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. In various embodiments, the special-purpose computing devices are desktop computer systems, portable computer systems, handheld devices, network devices or any other device that incorporates hard-wired and/or program logic to implement the techniques.

In an embodiment, the computer system 300 includes a bus 302 or other communication mechanism for communicating information, and a hardware processor 304 coupled with a bus 302 for processing information. The hardware processor 304 is, for example, a general-purpose microprocessor. The computer system 300 also includes a main memory 306, such as a random-access memory (RAM) or other dynamic storage device, coupled to the bus 302 for storing information and instructions to be executed by processor 304. In one implementation, the main memory 306 is used for storing temporary variables or other intermediate information during execution of instructions to be executed by the processor 304. Such instructions, when stored in non-transitory storage media accessible to the processor 304, render the computer system 300 into a special-purpose machine that is customized to perform the operations specified in the instructions.

In an embodiment, the computer system 300 further includes a read only memory (ROM) 308 or other static storage device coupled to the bus 302 for storing static information and instructions for the processor 304. A storage device 310, such as a magnetic disk, optical disk, solid-state drive, or three-dimensional cross point memory is provided and coupled to the bus 302 for storing information and instructions.

In an embodiment, the computer system 300 is coupled via the bus 302 to a display 312, such as a cathode ray tube (CRT), a liquid crystal display (LCD), plasma display, light emitting diode (LED) display, or an organic light emitting diode (OLED) display for displaying information to a computer user. An input device 314, including alphanumeric and other keys, is coupled to bus 302 for communicating information and command selections to the processor 304. Another type of user input device is a cursor controller 316, such as a mouse, a trackball, a touch-enabled display, or cursor direction keys for communicating direction information and command selections to the processor 304 and for controlling cursor movement on the display 312. This input device typically has two degrees of freedom in two axes, a first axis (e.g., x-axis) and a second axis (e.g., y-axis), that allows the device to specify positions in a plane.

According to one embodiment, the techniques herein are performed by the computer system 300 in response to the processor 304 executing one or more sequences of one or more instructions contained in the main memory 306. Such instructions are read into the main memory 306 from another storage medium, such as the storage device 310. Execution of the sequences of instructions contained in the main memory 306 causes the processor 304 to perform the process steps described herein. In alternative embodiments, hard-wired circuitry is used in place of or in combination with software instructions.

The term “storage media” as used herein refers to any non-transitory media that store data and/or instructions that cause a machine to operate in a specific fashion. Such storage media includes non-volatile media and/or volatile media. Non-volatile media includes, for example, optical disks, magnetic disks, solid-state drives, or three-dimensional cross point memory, such as the storage device 310. Volatile media includes dynamic memory, such as the main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NV-RAM, or any other memory chip or cartridge.

Storage media is distinct from but may be used in conjunction with transmission media. Transmission media participates in transferring information between storage media. For example, transmission media includes coaxial cables, copper wire and fiber optics, including the wires that comprise the bus 302. Transmission media can also take the form of acoustic or light waves, such as those generated during radio-wave and infrared data communications.

In an embodiment, various forms of media are involved in carrying one or more sequences of one or more instructions to the processor 304 for execution. For example, the instructions are initially carried on a magnetic disk or solid-state drive of a remote computer. The remote computer loads the instructions into its dynamic memory and send the instructions over a telephone line using a modem. A modem local to the computer system 300 receives the data on the telephone line and use an infrared transmitter to convert the data to an infrared signal. An infrared detector receives the data carried in the infrared signal and appropriate circuitry places the data on the bus 302. The bus 302 carries the data to the main memory 306, from which processor 304 retrieves and executes the instructions. The instructions received by the main memory 306 may optionally be stored on the storage device 310 either before or after execution by processor 304.

The computer system 300 also includes a communication interface 318 coupled to the bus 302. The communication interface 318 provides a two-way data communication coupling to a network link 320 that is connected to a local network 322. For example, the communication interface 318 is an integrated service digital network (ISDN) card, cable modem, satellite modem, or a modem to provide a data communication connection to a corresponding type of telephone line. As another example, the communication interface 318 is a local area network (LAN) card to provide a data communication connection to a compatible LAN. In some implementations, wireless links are also implemented. In any such implementation, the communication interface 318 sends and receives electrical, electromagnetic, or optical signals that carry digital data streams representing various types of information.

The network link 320 typically provides data communication through one or more networks to other data devices. For example, the network link 320 provides a connection through the local network 322 to a host computer 324 or to a cloud data center or equipment operated by an Internet Service Provider (ISP) 326. The ISP 326 in turn provides data communication services through the world-wide packet data communication network now commonly referred to as the “Internet” 328. The local network 322 and Internet 328 both use electrical, electromagnetic or optical signals that carry digital data streams. The signals through the various networks and the signals on the network link 320 and through the communication interface 318, which carry the digital data to and from the computer system 300, are example forms of transmission media. In an embodiment, the network 320 contains the cloud 202 or a part of the cloud 202 described above.

The computer system 300 sends messages and receives data, including program code, through the network(s), the network link 320, and the communication interface 318. In an embodiment, the computer system 300 receives code for processing. The received code is executed by the processor 304 as it is received, and/or stored in storage device 310, or other non-volatile storage for later execution.

### Autonomous Vehicle Architecture

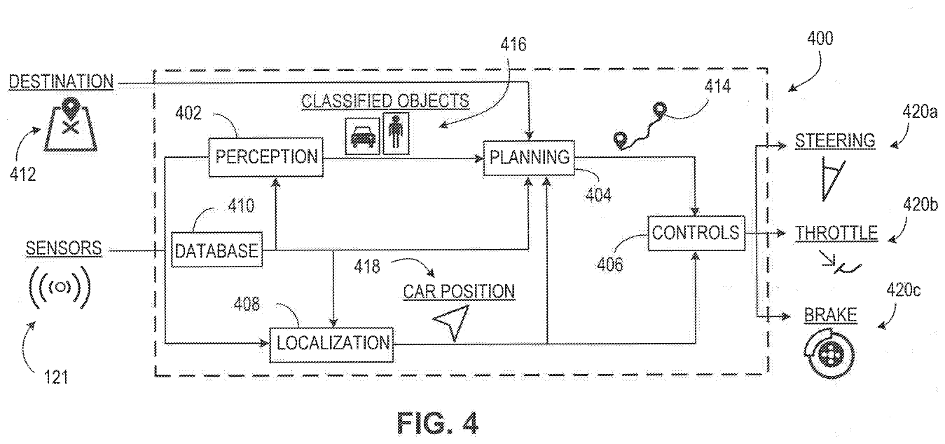

FIG. 4 shows an example architecture 400 for an autonomous vehicle (e.g., the AV 100 shown in FIG. 1). The architecture 400 includes a perception module 402 (sometimes referred to as a perception circuit), a planning module 404 (sometimes referred to as a planning circuit), a control module 406 (sometimes referred to as a control circuit), a localization module 408 (sometimes referred to as a localization circuit), and a database module 410 (sometimes referred to as a database circuit). Each module plays a role in the operation of the AV 100. Together, the modules 402, 404, 406, 408, and 410 may be part of the AV system 120 shown in FIG. 1. In some embodiments, any of the modules 402, 404, 406, 408, and 410 is a combination of computer software (e.g., executable code stored on a computer-readable medium) and computer hardware (e.g., one or more microprocessors, microcontrollers, application-specific integrated circuits [ASICs]), hardware memory devices, other types of integrated circuits, other types of computer hardware, or a combination of any or all of these things). Each of the modules 402, 404, 406, 408, and 410 is sometimes referred to as a processing circuit (e.g., computer hardware, computer software, or a combination of the two). A combination of any or all of the modules 402, 404, 406, 408, and 410 is also an example of a processing circuit.

In use, the planning module 404 receives data representing a destination 412 and determines data representing a trajectory 414 (sometimes referred to as a route) that can be traveled by the AV 100 to reach (e.g., arrive at) the destination 412. In order for the planning module 404 to determine the data representing the trajectory 414, the planning module 404 receives data from the perception module 402, the localization module 408, and the database module 410.

The perception module 402 identifies nearby physical objects using one or more sensors 121, e.g., as also shown in FIG. 1. The objects are classified (e.g., grouped into types such as pedestrian, bicycle, automobile, traffic sign, etc.) and a scene description including the classified objects 416 is provided to the planning module 404.

The planning module 404 also receives data representing the AV position 418 from the localization module 408. The localization module 408 determines the AV position by using data from the sensors 121 and data from the database module 410 (e.g., a geographic data) to calculate a position. For example, the localization module 408 uses data from a GNSS (Global Navigation Satellite System) sensor and geographic data to calculate a longitude and latitude of the AV. In an embodiment, data used by the localization module 408 includes high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations of them), and maps describing the spatial locations of road features such as crosswalks, traffic signs or other travel signals of various types. In an embodiment, the high-precision maps are constructed by adding data through automatic or manual annotation to low-precision maps.

The control module 406 receives the data representing the trajectory 414 and the data representing the AV position 418 and operates the control functions 420a-c (e.g., steering, throttling, braking, ignition) of the AV in a manner that will cause the AV 100 to travel the trajectory 414 to the destination 412. For example, if the trajectory 414 includes a left turn, the control module 406 will operate the control functions 420a-c in a manner such that the steering angle of the steering function will cause the AV 100 to turn left and the throttling and braking will cause the AV 100 to pause and wait for passing pedestrians or vehicles before the turn is made.

### Autonomous Vehicle Inputs

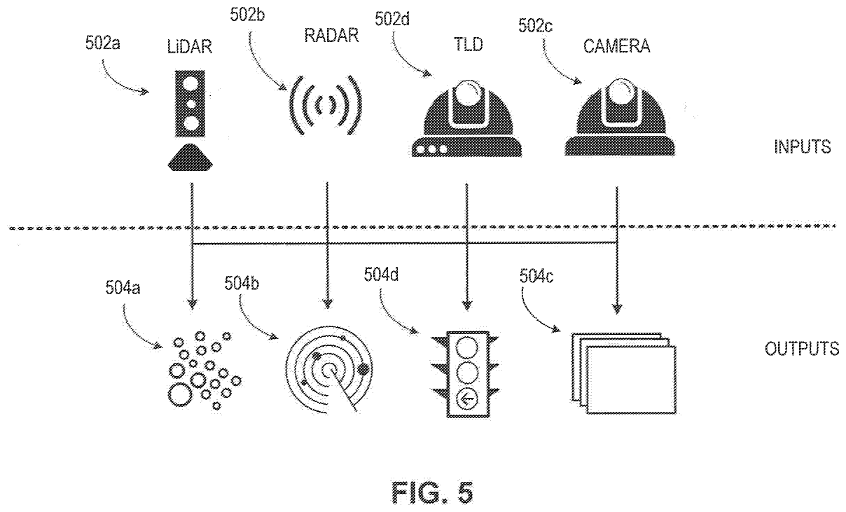

FIG. 5 shows an example of inputs 502a-d (e.g., sensors 121 shown in FIG. 1) and outputs 504a-d (e.g., sensor data) that is used by the perception module 402 (FIG. 4). One input 502a is a LiDAR (Light Detection and Ranging) system (e.g., LiDAR 123 shown in FIG. 1). LiDAR is a technology that uses light (e.g., bursts of light such as infrared light) to obtain data about physical objects in its line of sight. A LiDAR system produces LiDAR data as output 504a. For example, LiDAR data is collections of 3D or 2D points (also known as a point clouds) that are used to construct a representation of the environment 190.

Another input 502b is a RADAR system. RADAR is a technology that uses radio waves to obtain data about nearby physical objects. RADARs can obtain data about objects not within the line of sight of a LiDAR system. A RADAR system 502b produces RADAR data as output 504b. For example, RADAR data are one or more radio frequency electromagnetic signals that are used to construct a representation of the environment 190.

Another input 502c is a camera system. A camera system uses one or more cameras (e.g., digital cameras using a light sensor such as a charge-coupled device [CCD]) to obtain information about nearby physical objects. A camera system produces camera data as output 504c. Camera data often takes the form of image data (e.g., data in an image data format such as RAW, JPEG, PNG, etc.). In some examples, the camera system has multiple independent cameras, e.g., for the purpose of stereopsis (stereo vision), which enables the camera system to perceive depth. Although the objects perceived by the camera system are described here as “nearby,” this is relative to the AV. In use, the camera system may be configured to “see” objects far, e.g., up to a kilometer or more ahead of the AV. Accordingly, the camera system may have features such as sensors and lenses that are optimized for perceiving objects that are far away.

Another input 502d is a traffic light detection (TLD) system. A TLD system uses one or more cameras to obtain information about traffic lights, street signs, and other physical objects that provide visual navigation information. A TLD system produces TLD data as output 504d. TLD data often takes the form of image data (e.g., data in an image data format such as RAW, JPEG, PNG, etc.). A TLD system differs from a system incorporating a camera in that a TLD system uses a camera with a wide field of view (e.g., using a wide-angle lens or a fish-eye lens) in order to obtain information about as many physical objects providing visual navigation information as possible, so that the AV 100 has access to all relevant navigation information provided by these objects. For example, the viewing angle of the TLD system may be about 120 degrees or more.

In some embodiments, outputs 504a-d are combined using a sensor fusion technique. Thus, either the individual outputs 504a-d are provided to other systems of the AV 100 (e.g., provided to a planning module 404 as shown in FIG. 4), or the combined output can be provided to the other systems, either in the form of a single combined output or multiple combined outputs of the same type (e.g., using the same combination technique or combining the same outputs or both) or different types type (e.g., using different respective combination techniques or combining different respective outputs or both). In some embodiments, an early fusion technique is used. An early fusion technique is characterized by combining outputs before one or more data processing steps are applied to the combined output. In some embodiments, a late fusion technique is used. A late fusion technique is characterized by combining outputs after one or more data processing steps are applied to the individual outputs.

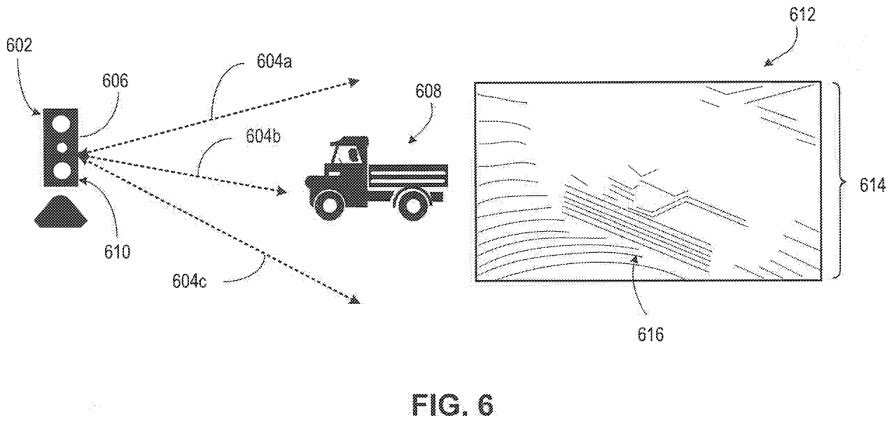

FIG. 6 shows an example of a LiDAR system 602 (e.g., the input 502a shown in FIG. 5). The LiDAR system 602 emits light 604a-c from a light emitter 606 (e.g., a laser transmitter). Light emitted by a LiDAR system is typically not in the visible spectrum; for example, infrared light is often used. Some of the light 604b emitted encounters a physical object 608 (e.g., a vehicle) and reflects back to the LiDAR system 602. (Light emitted from a LiDAR system typically does not penetrate physical objects, e.g., physical objects in solid form.) The LiDAR system 602 also has one or more light detectors 610, which detect the reflected light. In an embodiment, one or more data processing systems associated with the LiDAR system generates an image 612 representing the field of view 614 of the LiDAR system. The image 612 includes information that represents the boundaries 616 of a physical object 608. In this way, the image 612 is used to determine the boundaries 616 of one or more physical objects near an AV.

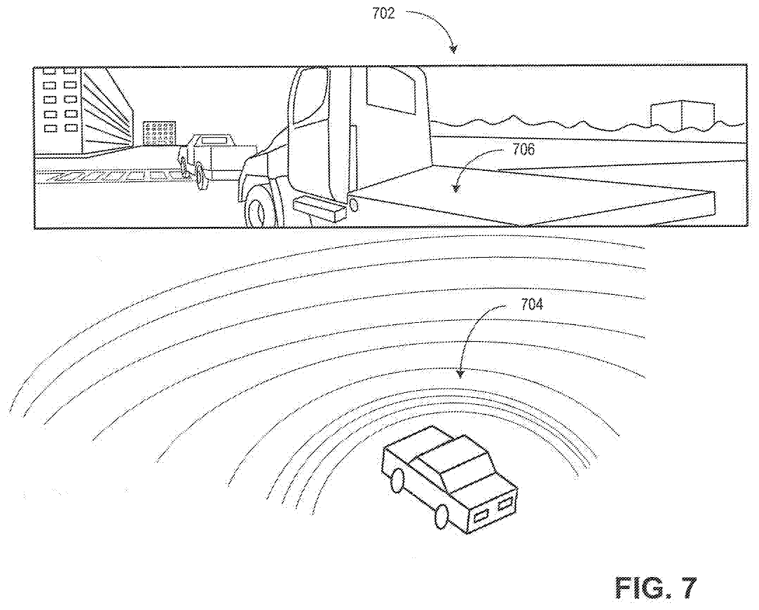

FIG. 7 shows the LiDAR system 602 in operation. In the scenario shown in this figure, the AV 100 receives both camera system output 504c in the form of an image 702 and LiDAR system output 504a in the form of LiDAR data points 704. In use, the data processing systems of the AV 100 compares the image 702 to the data points 704. In particular, a physical object 706 identified in the image 702 is also identified among the data points 704. In this way, the AV 100 perceives the boundaries of the physical object based on the contour and density of the data points 704.

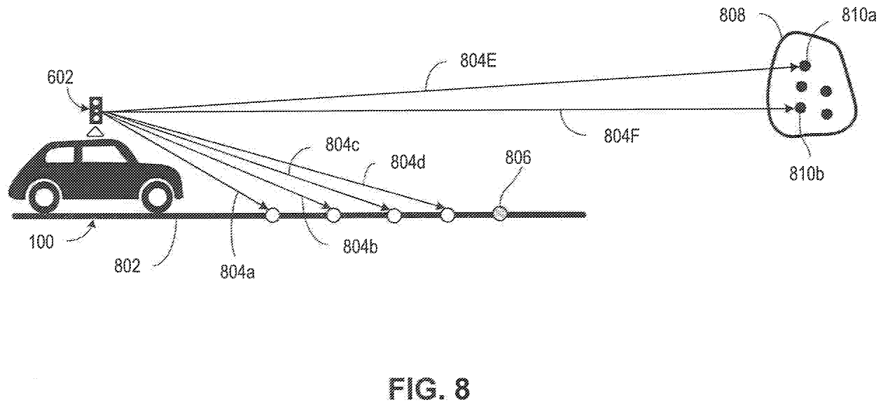

FIG. 8 shows the operation of the LiDAR system 602 in additional detail. As described above, the AV 100 detects the boundary of a physical object based on characteristics of the data points detected by the LiDAR system 602. As shown in FIG. 8, a flat object, such as the ground 802, will reflect light 804a-d emitted from a LiDAR system 602 in a consistent manner. Put another way, because the LiDAR system 602 emits light using consistent spacing, the ground 802 will reflect light back to the LiDAR system 602 with the same consistent spacing. As the AV 100 travels over the ground 802, the LiDAR system 602 will continue to detect light reflected by the next valid ground point 806 if nothing is obstructing the road. However, if an object 808 obstructs the road, light 804e-f emitted by the LiDAR system 602 will be reflected from points 810a-b in a manner inconsistent with the expected consistent manner. From this information, the AV 100 can determine that the object 808 is present.

### Path Planning

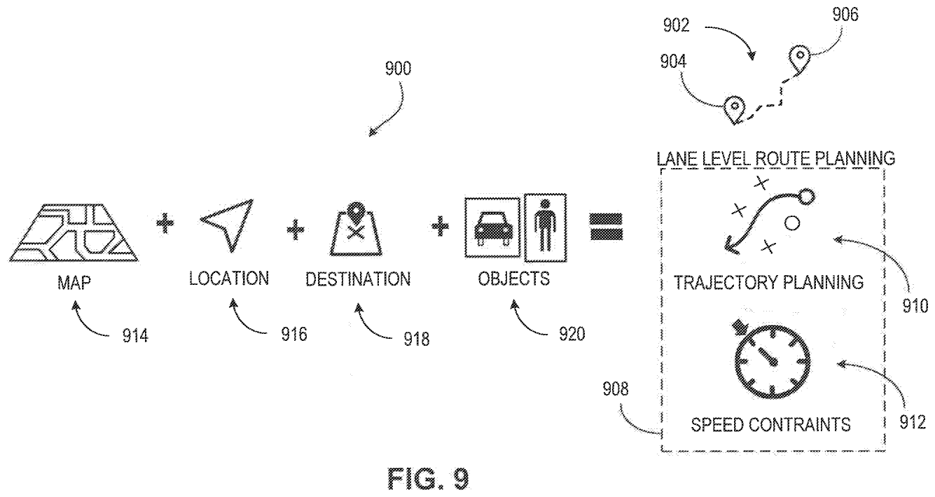

FIG. 9 shows a block diagram 900 of the relationships between inputs and outputs of a planning module 404 (e.g., as shown in FIG. 4). In general, the output of a planning module 404 is a route 902 from a start point 904 (e.g., source location or initial location), and an end point 906 (e.g., destination or final location). The route 902 is typically defined by one or more segments. For example, a segment is a distance to be traveled over at least a portion of a street, road, highway, driveway, or other physical area appropriate for automobile travel. In some examples, e.g., if the AV 100 is an off-road capable vehicle such as a four-wheel-drive (4WD) or all-wheel-drive (AWD) car, SUV, pick-up truck, or the like, the route 902 includes “off-road” segments such as unpaved paths or open fields.

In addition to the route 902, a planning module also outputs lane-level route planning data 908. The lane-level route planning data 908 is used to traverse segments of the route 902 based on conditions of the segment at a particular time. For example, if the route 902 includes a multi-lane highway, the lane-level route planning data 908 includes trajectory planning data 910 that the AV 100 can use to choose a lane among the multiple lanes, e.g., based on whether an exit is approaching, whether one or more of the lanes have other vehicles, or other factors that vary over the course of a few minutes or less. Similarly, in some implementations, the lane-level route planning data 908 includes speed constraints 912 specific to a segment of the route 902. For example, if the segment includes pedestrians or un-expected traffic, the speed constraints 912 may limit the AV 100 to a travel speed slower than an expected speed, e.g., a speed based on speed limit data for the segment.

In an embodiment, the inputs to the planning module 404 includes database data 914 (e.g., from the database module 410 shown in FIG. 4), current location data 916 (e.g., the AV position 418 shown in FIG. 4), destination data 918 (e.g., for the destination 412 shown in FIG. 4), and object data 920 (e.g., the classified objects 416 as perceived by the perception module 402 as shown in FIG. 4). In some embodiments, the database data 914 includes rules used in planning. Rules are specified using a formal language, e.g., using Boolean logic. In any given situation encountered by the AV 100, at least some of the rules will apply to the situation. A rule applies to a given situation if the rule has conditions that are met based on information available to the AV 100, e.g., information about the surrounding environment. Rules can have priority. For example, a rule that says, “if the road is a freeway, move to the leftmost lane” can have a lower priority than “if the exit is approaching within a mile, move to the rightmost lane.”

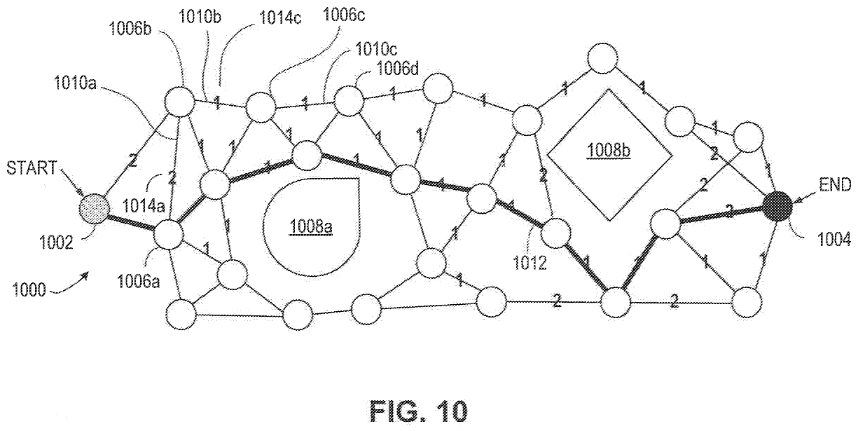

FIG. 10 shows a directed graph 1000 used in path planning, e.g., by the planning module 404 (FIG. 4). In general, a directed graph 1000 like the one shown in FIG. 10 is used to determine a path between any start point 1002 and end point 1004. In real-world terms, the distance separating the start point 1002 and end point 1004 may be relatively large (e.g., in two different metropolitan areas) or may be relatively small (e.g., two intersections abutting a city block or two lanes of a multi-lane road).

In an embodiment, the directed graph 1000 has nodes 1006a-d representing different locations between the start point 1002 and the end point 1004 that could be occupied by an AV 100. In some examples, e.g., when the start point 1002 and end point 1004 represent different metropolitan areas, the nodes 1006a-d represent segments of roads. In some examples, e.g., when the start point 1002 and the end point 1004 represent different locations on the same road, the nodes 1006a-d represent different positions on that road. In this way, the directed graph 1000 includes information at varying levels of granularity. In an embodiment, a directed graph having high granularity is also a subgraph of another directed graph having a larger scale. For example, a directed graph in which the start point 1002 and the end point 1004 are far away (e.g., many miles apart) has most of its information at a low granularity and is based on stored data, but also includes some high granularity information for the portion of the graph that represents physical locations in the field of view of the AV 100.

The nodes 1006a-d are distinct from objects 1008a-b, which cannot overlap with a node. In an embodiment, when granularity is low, the objects 1008a-b represent regions that cannot be traversed by automobile, e.g., areas that have no streets or roads. When granularity is high, the objects 1008a-b represent physical objects in the field of view of the AV 100, e.g., other automobiles, pedestrians, or other entities with which the AV 100 cannot share physical space. In an embodiment, some or all of the objects 1008a-b are a static objects (e.g., an object that does not change position such as a street lamp or utility pole) or dynamic objects (e.g., an object that is capable of changing position such as a pedestrian or other car).

The nodes 1006a-d are connected by edges 1010a-c. If two nodes 1006a-b are connected by an edge 1010a, it is possible for an AV 100 to travel between one node 1006a and the other node 1006b, e.g., without having to travel to an intermediate node before arriving at the other node 1006b. (When we refer to an AV 100 traveling between nodes, we mean that the AV 100 travels between the two physical positions represented by the respective nodes.) The edges 1010a-c are often bidirectional, in the sense that an AV 100 travels from a first node to a second node, or from the second node to the first node. In an embodiment, edges 1010a-c are unidirectional, in the sense that an AV 100 can travel from a first node to a second node, however the AV 100 cannot travel from the second node to the first node. Edges 1010a-c are unidirectional when they represent, for example, one-way streets, individual lanes of a street, road, or highway, or other features that can only be traversed in one direction due to legal or physical constraints.

In an embodiment, the planning module 404 uses the directed graph 1000 to identify a path 1012 made up of nodes and edges between the start point 1002 and end point 1004.

An edge 1010a-c has an associated cost 1014a-b. The cost 1014a-b is a value that represents the resources that will be expended if the AV 100 chooses that edge. A typical resource is time. For example, if one edge 1010a represents a physical distance that is twice that as another edge 1010b, then the associated cost 1014a of the first edge 1010a may be twice the associated cost 1014b of the second edge 1010b. Other factors that affect time include expected traffic, number of intersections, speed limit, etc. Another typical resource is fuel economy. Two edges 1010a-b may represent the same physical distance, but one edge 1010a may require more fuel than another edge 1010b, e.g., because of road conditions, expected weather, etc.

When the planning module 404 identifies a path 1012 between the start point 1002 and end point 1004, the planning module 404 typically chooses a path optimized for cost, e.g., the path that has the least total cost when the individual costs of the edges are added together.

### Autonomous Vehicle Control

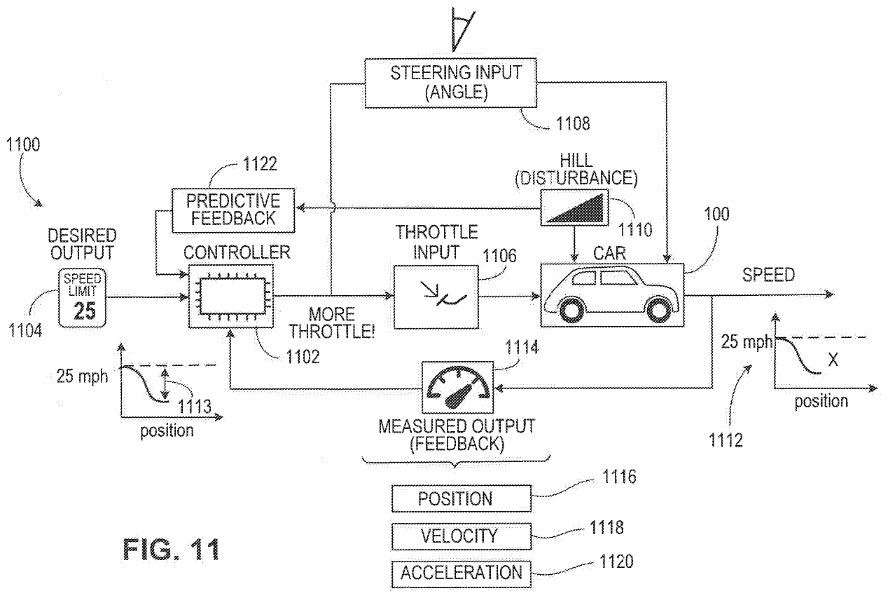

FIG. 11 shows a block diagram 1100 of the inputs and outputs of a control module 406 (e.g., as shown in FIG. 4). A control module operates in accordance with a controller 1102 which includes, for example, one or more processors (e.g., one or more computer processors such as microprocessors or microcontrollers or both) similar to processor 304, short-term and/or long-term data storage (e.g., memory random-access memory or flash memory or both) similar to main memory 306, ROM 1308, and storage device 210, and instructions stored in memory that carry out operations of the controller 1102 when the instructions are executed (e.g., by the one or more processors).

In an embodiment, the controller 1102 receives data representing a desired output 1104. The desired output 1104 typically includes a velocity, e.g., a speed and a heading. The desired output 1104 can be based on, for example, data received from a planning module 404 (e.g., as shown in FIG. 4). In accordance with the desired output 1104, the controller 1102 produces data usable as a throttle input 1106 and a steering input 1108. The throttle input 1106 represents the magnitude in which to engage the throttle (e.g., acceleration control) of an AV 100, e.g., by engaging the steering pedal, or engaging another throttle control, to achieve the desired output 1104. In some examples, the throttle input 1106 also includes data usable to engage the brake (e.g., deceleration control) of the AV 100. The steering input 1108 represents a steering angle, e.g., the angle at which the steering control (e.g., steering wheel, steering angle actuator, or other functionality for controlling steering angle) of the AV should be positioned to achieve the desired output 1104.

In an embodiment, the controller 1102 receives feedback that is used in adjusting the inputs provided to the throttle and steering. For example, if the AV 100 encounters a disturbance 1110, such as a hill, the measured speed 1112 of the AV 100 is lowered below the desired output speed. In an embodiment, any measured output 1114 is provided to the controller 1102 so that the necessary adjustments are performed, e.g., based on the differential 1113 between the measured speed and desired output. The measured output 1114 includes measured position 1116, measured velocity 1118, (including speed and heading), measured acceleration 1120, and other outputs measurable by sensors of the AV 100.

In an embodiment, information about the disturbance 1110 is detected in advance, e.g., by a sensor such as a camera or LiDAR sensor, and provided to a predictive feedback module 1122. The predictive feedback module 1122 then provides information to the controller 1102 that the controller 1102 can use to adjust accordingly. For example, if the sensors of the AV 100 detect (“see”) a hill, this information can be used by the controller 1102 to prepare to engage the throttle at the appropriate time to avoid significant deceleration.

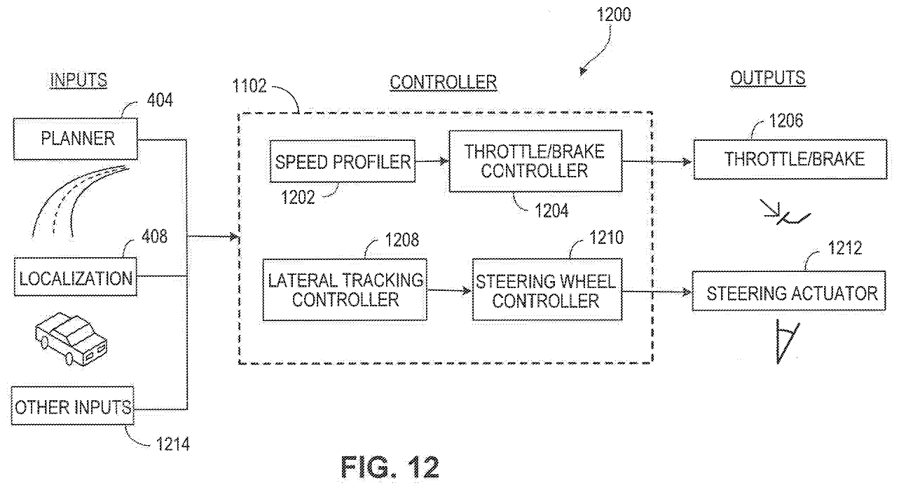

FIG. 12 shows a block diagram 1200 of the inputs, outputs, and components of the controller 1102. The controller 1102 has a speed profiler 1202 which affects the operation of a throttle/brake controller 1204. For example, the speed profiler 1202 instructs the throttle/brake controller 1204 to engage acceleration or engage deceleration using the throttle/brake 1206 depending on, e.g., feedback received by the controller 1102 and processed by the speed profiler 1202.

The controller 1102 also has a lateral tracking controller 1208 which affects the operation of a steering controller 1210. For example, the lateral tracking controller 1208 instructs the steering controller 1210 to adjust the position of the steering angle actuator 1212 depending on, e.g., feedback received by the controller 1102 and processed by the lateral tracking controller 1208.

The controller 1102 receives several inputs used to determine how to control the throttle/brake 1206 and steering angle actuator 1212. A planning module 404 provides information used by the controller 1102, for example, to choose a heading when the AV 100 begins operation and to determine which road segment to traverse when the AV 100 reaches an intersection. A localization module 408 provides information to the controller 1102 describing the current location of the AV 100, for example, so that the controller 1102 can determine if the AV 100 is at a location expected based on the manner in which the throttle/brake 1206 and steering angle actuator 1212 are being controlled. In an embodiment, the controller 1102 receives information from other inputs 1214, e.g., information received from databases, computer networks, etc.

### Classifying Perceived Objects Based on Activity

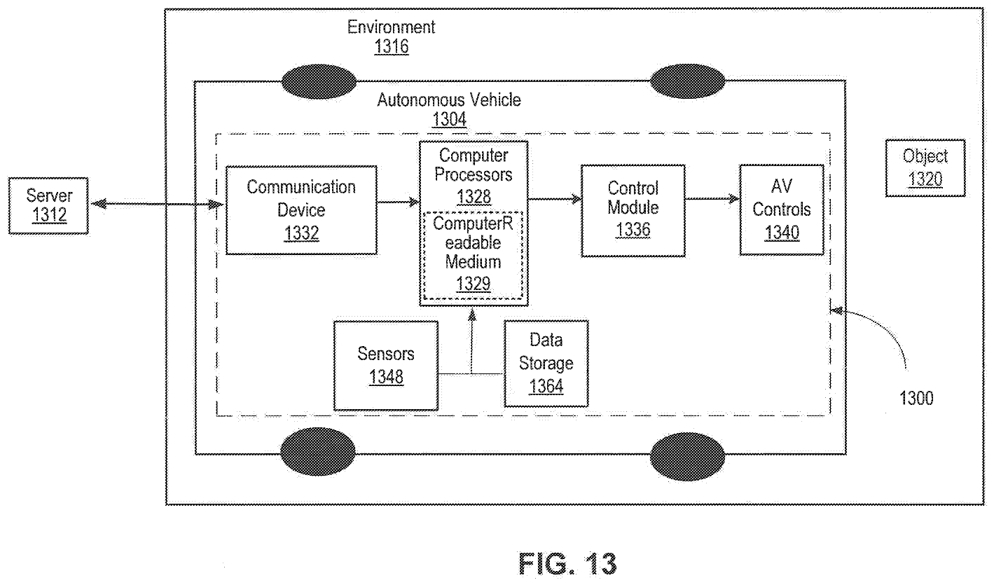

FIG. 13 is an illustrative example showing an environment 1316 including a vehicle 1304 having a system 1300 for classifying one or more perceived objects 1320 based on activity, according to one or more embodiments of the present disclosure. The system 1300 includes sensors 1348, data storage 1364, a communication device 1332, computer processors 1328, a control module 1336, and AV controls 1340 (e.g., steering, brakes, throttle, etc.).

The sensors 1348 are configured to receive sensor information corresponding to at least one target object 1320 (e.g., vehicle, pedestrian, road fixture, traffic sign/light, debris, etc.) proximate to the AV 1304. The sensors 1348 can include one or more sensors. The sensors 1348 can include one or more types of sensing devices. For example, in an embodiment, the sensors 1348 includes one of the sensors 121 discussed previously with reference to FIG. 1. In an embodiment, the sensors 1348 include one or more of the inputs 502a-c as discussed previously with reference to FIG. 5. In an embodiment, the sensors 1348 include a LiDAR and/or a camera. The camera can be a monocular or stereo video camera configured to capture light in the visible, infrared, and/or thermal spectra. In an embodiment, the sensors 1348 include at least one ultrasonic sensor. In an embodiment, the sensors 1348 include at least one radar. At least one of the sensors 1348 can also include a combination of sensing devices. For example, in an embodiment, at least one of the sensors 1348 includes a camera and a radar. In an embodiment, at least one of the sensors 1348 also includes additional sensors for sensing or measuring properties of the AV's 1304 environment 1316. For example, the additional sensors can include monocular or stereo video cameras 122 in the visible light, infrared or thermal (or both) spectra; LiDAR 123; RADAR; ultrasonic or other auditory sensors such as array microphones; time-of-flight (TOF) depth sensors; speed sensors; temperature sensors: humidity sensors: and precipitation sensors.

The communication device 1332 may be an embodiment of the communication device 140 shown in FIG. 1. In an embodiment, the communication device 1332 is communicatively coupled to a server 1312 across a network. In an embodiment, the communication device 1332 communicates across the Internet, an electromagnetic spectrum (including radio and optical communications), or other media (e.g., air and acoustic media). Portions of the communication device 1332 may be implemented in software or hardware. In one example, the communication device 1332 or a portion of the communication device 1332 is part of a PC, a tablet PC, an STB, a smartphone, an internet of things (IoT) appliance, or any machine capable of executing instructions that specify actions to be taken by that machine. The communication device 1332 is described in more detail above with reference to communication device 140 in FIG. 1.

The AV controls 1340 may be an embodiment of the controls 420a-c shown in FIG. 4. The control module 1336 may be an embodiment of the control module 406 shown in FIG. 4. In some implementations, the control module 406 operates in accordance with a controller circuit, which includes, for example, one or more processors (e.g., one or more computer processors such as microprocessors or microcontrollers or both) similar to processor 304, short-term and/or long-term data storage (e.g., memory random-access memory or flash memory or both) similar to main memory 306, ROM, and storage device 210, and instructions stored in memory that carry out operations of the controller circuit when the instructions are executed (e.g., by the one or more processors). The AV controls 1340 receive commands from the control module 1336 and adjust the steering, brakes, and throttle of the AV 1304 in accordance with the received commands. In one embodiment, portions of the AV controls 1340 are implemented in software or hardware. For example, the AV controls 1340 or a portion of the AV controls 1340 may be part of a PC, a tablet PC, an STB, a smartphone, an internet of things (IoT) appliance, or any machine capable of executing instructions that specify actions to be taken by that machine. The AV controls 1340 are described in more detail above with reference to modules 406 and 420a-c in FIG. 4.

The data storage 1364 is an embodiment of the data storage 142 or memory 144 shown in FIG. 1 and includes one or more of semiconductor based memory devices, magnetic memory devices and systems, optical memory devices and systems, fixed memory, removable memory, disc memory, flash memory, dynamic random-access memory (DRAM), static random-access memory (SRAM), electronically erasable programmable read-only memory (EEPROM) and the like.

The computer processors 1328 include a computer-readable medium 1329. The computer-readable medium 1329 (or computer-readable memory) can include any data storage technology type which is suitable to the local technical environment, including but not limited to semiconductor based memory devices, magnetic memory devices and systems, optical memory devices and systems, fixed memory, removable memory, disc memory, flash memory, dynamic random-access memory (DRAM), static random-access memory (SRAM), electronically erasable programmable read-only memory (EEPROM) and the like. In an embodiment, the computer-readable medium 1329 stores code-segment having computer-executable instructions.

In an embodiment, the computer processors 1328 include one or more trained deep learning models. In an embodiment, the computer processors 1328 include a Bayesian model machine learning processor. A Bayesian model machine learning processor uses one or more Bayesian techniques, such as parameter estimation (e.g., approximate the posterior distribution over a plurality of parameters given some observed data) and/or model comparison (e.g., comparing output of a set of approximation algorithms), to make inferences according to observed data. In an embodiment, the computer processors 1328 include a deep learning model machine learning processor. A deep learning model machine learning processors uses one or more deep learning techniques, such as feature learning that allows the processor to automatically discover the representations needed for feature detection, to perform specific tasks (e.g., classification). In an embodiment, the deep learning model machine learning processor includes a feed-forward neural network, a convolutional neural network, a radial basis function neural network, a recurrent neural network, and/or a modular neural network.

In an embodiment, the computer processors 1328 include one or more computer processors (e.g., microprocessors, microcontrollers, or both) similar to the processor 304 discussed earlier with reference to FIG. 3. The computer processors 1328 are configured to execute program code such as the computer-executable instructions stored on the computer-readable medium 1329. The computer processors 1328 are configured to be communicatively coupled to the sensors 1348, controller circuit 1336, communication device 1332, and/or the data storage 1364. When the computer processors 1330 execute the computer-executable instructions, the computer processors 1330 are caused to carry out several operations.

In an embodiment, when the computer processors 1328 execute the computer-executable instructions, the computer processors 1328 are configured to receive sensor information from the sensors 1348. The sensor information can include object detection, speed, and/or location data (e.g., location of vehicles, pedestrians, traffic lights, traffic signs, road/lane markings, etc.) of target objects 1320 proximate to the AV 1304. As indicated earlier, a target object 1320 can be, for example, a vehicle (e.g., car, scooter, bicycle, etc.), pedestrian, road fixture, and so forth.

In an embodiment, when the computer processors 1328 execute the computer-executable instructions, the computer processors 1328 are configured to determine an activity prediction for at least one target object 1320 proximate to the AV 1304 in accordance with the received sensor information. For example, in an embodiment, the computer processors 1328 determine a likelihood that a target vehicle proximate to the AV 1304 will be stationary for a certain period of time (e.g., for 10 seconds, 30 seconds, 1 minute, etc.). As will be explained later, this determination can be used to classify one or more target objects 1320 proximate to the vehicle. In an embodiment, determining an activity prediction includes determining one or more attributes associated with a target object 1320 proximate to the AV 1304. For example, the computer processors 1328 determine, based on the received sensor information, the road lane in which a target vehicle is located, a target vehicle's distance to a stop light/sign, a target vehicle's distance to a designated car park, the amount of free space in front of target object, the speed limit of the area in which a target vehicle is operating, whether an occupant is within a target vehicle, whether a target vehicle's hazard lights are blinking, whether a target vehicle's tail lights are active, whether a target vehicle's exhaust and/or engine is hot, whether a target vehicle was moving within a previous period of time, whether there are other target vehicles immediately in front of a target vehicle, and so forth.

In an embodiment, the computer processors 1328 are configured to assign one or more weights to the determined attributes of the detected target objects 1320. The attributes are determined based on the data received from the sensors 1348. For example, the computer processors 1328 are configured to use a Bayesian model machine learning processor that assigns weights to certain features detected by a camera or LiDAR, such as the lane in which a target vehicle is operating, whether or not a target vehicle's doors are open/closed, whether or not a target vehicle's engine is running based on audiovisual cues such as the engine sound, and so forth. The assigned weights can be based on learning which particular factors influence a determination of the state of the target vehicle, when compared to the other factors, on predicting whether or not a target object 1320 is likely to be stationary (or to continue moving) for a certain time period. For instance, in an embodiment, the computer processors 1328 learn, through one or more machine learning techniques discussed previously, that a target vehicle's engine being turned off is more indicative that the target vehicle will remain stationary for a certain period of time than the object being in a parking lane, and the computer processors 1328 assign weights to each attribute accordingly (e.g., higher weight values for the fact that the target vehicle's engine is not running). In an embodiment, the weights are used to produce a prediction value (e.g., prediction score) associated with the likelihood that a target object 1320 will remain stationary and/or in motion. In an embodiment, the manner in which the computer processors 1328 assign the weights are continuously updated based on, for instance, feedback information. The computer processors 1328 or a human operator can determine, based on the resulting output (e.g., inferences), whether the output exceeds an error threshold and, if the output does exceed an error threshold, update (e.g., adjust) the weighting scheme accordingly. For example, if the computer processors 1328, based on the received sensor information and the weighting scheme, predict that a target object 1320 will remain stationary for 30 seconds, and the target object 1320 actually remains stationary for only 10 seconds, the computer processors 1328 can determine an error of 20 seconds. If 20 seconds exceeds the error threshold (e.g., 15 seconds), the weighting scheme used to determine the predicted activity can be updated in a manner to reduce the associated error.

In an embodiment, the computer processors 1328 are configured to rank the factors that influence a determination of a state of the target object 1320. The computer processors 1328 then determine the state based on a comparison between the relative ranks of the various factors. In an embodiment, the ranking is pre-determined based on machine learning techniques. In an embodiment, the rankings are pre-determined based on human input.

In an embodiment, when the computer processors 1328 execute the computer-executable instructions, the computer processors 1328 are configured to classify the at least one target object 1320 proximate to the AV 1304 in accordance with the activity prediction. In an embodiment, classifying a target object 1320 includes determining the likelihood that the object 1320 is inactive or active. In an embodiment, the computer processors 1328 determine if the object 1320 is active or inactive based on the amount of time an object 1320 is predicted to remain stationary or remain mobile (e.g., predicted activity).

For example, in an embodiment, if the received sensor information indicates that a target vehicle is moving forward and its engine is running, the computer processors 1328 determine that the target vehicle will remain in motion for at least 30 additional seconds, and based on that determination, the computer processors 1328 classify the target vehicle as active. If the received sensor information indicates that a target vehicle is stationary with its engine not running, and that there are no passengers in the target vehicle, the computer processors 1328 determine that the target car will remain stationary for at least 30 additional seconds, and based on this determination, can classify the target vehicle as inactive. If the sensor information indicates that a target vehicle is stationary, but has its engine running, an activated turn signal (sometimes referred to as a blinker) signifying that the target vehicle may be pulling into traffic, and that a driver is within the target vehicle looking over their shoulder, the computer processors 1328 determine that the target vehicle will not remain stationary for at least 30 additional seconds, and based on that determination, classify the target vehicle as active. Other factors that may lead to determining that a target object 1320 is active (e.g., will remain in motion for a certain period of time or will not remain stationary for a certain period of time) can include whether the sensor information indicates that a target vehicle is stopped in front of a stop light, whether the sensor information indicates that a target vehicle is onboarding passengers, whether the sensor information indicates that a target vehicle is traversing a highway, whether the sensor information indicates that a target vehicle is operating in dense traffic conditions, whether the sensor information indicates that a target vehicle's turn signals are activated, whether the sensor information indicates that a target object 1320 is a stationary road fixture (e.g., fire hydrant, street lamp, etc.), whether the sensor information indicates that a target object 1320 is a pedestrian entering a crosswalk, and so forth. The predetermined time interval may be a user/manufacturer choice or can be learned by the computer processors 1328 (e.g., using one or more machine learning techniques) and can be based on, for example, safety, efficiency and practical considerations.

In an embodiment, classifying a target object 1320 includes assigning an overtake value to the target object 1320. For example, the computer processors 1328 produce a score relating to whether the AV 1304 should pass the target object (e.g., by increasing the speed of the AV 1304 and maneuvering the AV 1304 around the target object 1320). The overtake value can be associated with the weighting scheme, as discussed previously, for determining the likelihood that a target object 1320 will remain static or in motion (e.g., based on engine heat values, presence of passengers/drivers, driver body position, distance to stop lights, etc.).

In an embodiment, the computer processors 1328 are configured to receive historical sensor information from, for example, the data storage 1364 and/or the server 1312, and based on the historical sensor information, in addition to the received current sensor information, determine that a target object 1320 is active/inactive. For example, at a previous point in time, the AV 1304 may have passed a target vehicle determined to be parked and inactive. Upon reaching the same location, if the received current sensor information indicates that the target vehicle is stationary at the same parked location, the computer processors 1328 determine that the target vehicle is inactive based on the current sensor formation and the stored historical sensor information.

In an embodiment, the computer processors 1328 generate an uncertainty value corresponding to the classification of the at least one target object 1320. The uncertainty value can be assigned in accordance with the weighting scheme discussed previously and/or historical data such as data associated with the accuracy of past predictions. For example, in an embodiment, the computer processors 1328 assign higher uncertainty values to classifications associated with target objects 1320 that have been classified as active with a lower prediction score (based on the weighting scheme) than target objects 1320 that have been classified as active with a higher prediction score. As previously indicated, the weighting scheme can be based on determinations of the accuracy of previous classifications, and thus the uncertainty values can also be based on the accuracy of previous classifications.

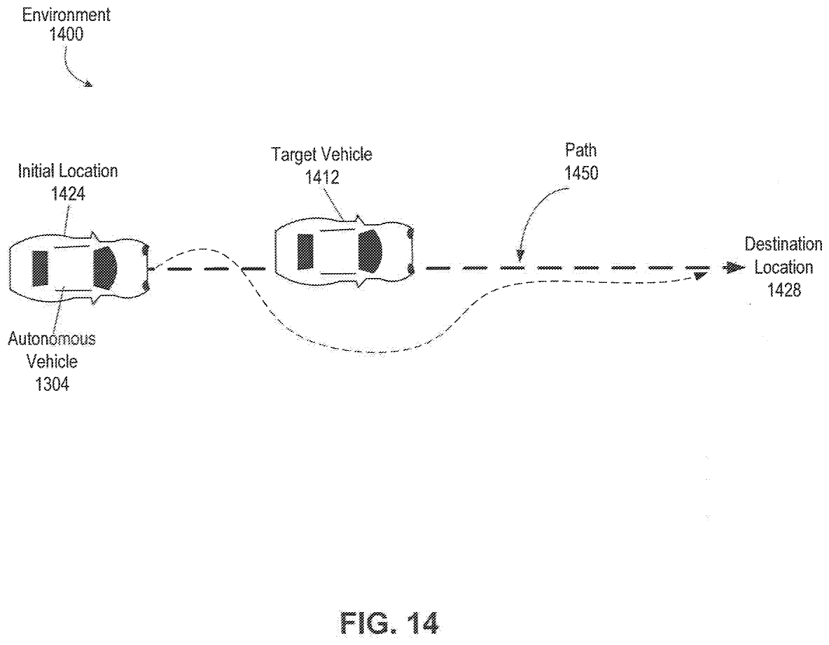

In an embodiment, when the computer processors 1328 execute the computer-executable instructions, the computer processors 1328 are configured to cause the control module 1336 (e.g., the controller circuit) to operate the AV controls 1340 (e.g., control functions) of the AV 1304 at least partially based on the classification of the at least one target object 1320. For example, in an embodiment, the control module 1336 operates the AV controls 1340 in such a manner to cause the AV 1304 to overtake a target object 1320 when the computer processors 1328 classify the target object 1320 as inactive. FIG. 14 shows an environment 1400 in which the AV 1304 overtakes a target vehicle 1412 based on the classification of the target vehicle 1412, according to one or more embodiments of the present disclosure. As shown in FIG. 14, the AV 1304 approaches the target vehicle 1412 while traversing a path 1450 towards a destination location 1428. The sensor information indicates, for example, that the target vehicle 1412 is slight offset from the path 1450, is stationary, does not have a running engine, and no drivers/passengers are present in the target vehicle 1412. Based on this information, the AV 1304 determines that the target vehicle 1412 is inactive, and determines to overtake the target vehicle 1412. The control module 1336 operates the AV controls 1340 (e.g., by transmitting control signals to the AV controls 1340) in a manner to cause the AV 1304 to maneuver around the target vehicle 1412.

Referring back to FIG. 13, in an embodiment, the control module 1336 operates the AV controls 1340 at least partially based on at least one road rule. For example, the computer processors 1328 cause the control module 1336 to operate the AV controls 1340 in accordance with laws regarding speed limits, lane violations, traffic light violations, and so forth. In an embodiment, the control module 1336 operates the AV controls 1340 in a manner to cause the AV 1304 to change its route of traverse. For example, if the AV 1304 is traversing a first route (e.g., a primary route) and the computer processors 1328 determine that a significant number of target objects 1320 are inactive (e.g., 5, 10, 20, etc.), the computer processors 1328 cause the control module 1336 to operate the AV controls 1340 such that the AV 1304 traverses a second route (e.g., an alternate route).

In an embodiment, the control module 1336 operates the AV controls 1340 to cause the AV 1304 to approach a target object 1320 at a predetermined speed. The predetermined speed can be a reduced speed relative to a posted speed limit. In an embodiment, the control module 1336 operates the AV controls 1340 to cause the AV 1304 to maintain a predetermine distance from a target object 1320. The predetermined distance can be an increased distance relative to recommended distances that should be maintained based on safety considerations (e.g., the California Driver Handbook recommends a two second following distance based on the current travelling speed of a vehicle). The predetermined speed and/or distance can be based on the uncertainty value associated with the classification of a target object 1320. For example, if the uncertainty value exceeds an uncertainty value threshold (e.g., 30% uncertain), the AV 1304 can be caused to maintain a larger distance and a slower speed than when the target object's 1320 classification is associated with a lower uncertainty value (e.g., 20% uncertain).

In an embodiment, the control module 1336 operates the AV controls 1340 to cause the AV 1304 to either stop or slow down when an uncertainty value associated with a classification of a target object meets an uncertainty value threshold. In an embodiment, when the AV 1304 is either caused to stop or slow down, the computer processors 1328 cause the sensors 1348 to capture additional sensor information corresponding to the target object. For example, assume that a target object 1320 has been assigned a classification with an uncertainty value of 30% or higher. If the uncertainty value threshold is 29%, the uncertainty value assigned to the classification can be determined to meet the uncertainty value threshold, and the AV 1304 can be caused to stop or approach the target object at a predetermined speed (e.g., 5 mph, 10 mph, etc.) so that the sensors 1348 capture additional sensor information associated with the target object 1320 (e.g., amount of time the target object is remaining stationary, number of passengers in a target vehicle, changing heat values associated with a target car's engine, etc.). The additional sensor information can be used to adjust the assigned classification or the uncertainty value corresponding to the assigned classification.

In an embodiment, the control module 1336 operates the AV controls 1340 such that the AV 1304 is caused to travel at a predicted speed. In an embodiment, the predicted speed is based at least partially on learned human-like behavior. For example, the computer processors 1328 use the sensors 1348 to observe a human driver navigating an environment (either in the AV 1304 or another vehicle) and learn, through one or more machine learning techniques (e.g., deep learning), to replicate the observed behavior in terms of predicting the speed at which the AV 1304 should travel in a given situation. In an embodiment, the computer processors 1328 access driving logs associated with a human driver (e.g., from the data storage 1364 and/or the server 1312), which can include video associated with the human driver's actions and/or historical speed data associated with the human driver's actions. Based on the observations and/or driving logs, the computer processors 1328 learn to replicate the actions taken by a human driver when encountering similar situations as the human driver. Thus, the computer processors 1328 learn, for example, to overtake (e.g., pass) parked/inactive target objects 1320 more aggressively than target objects 1320 that may pull into traffic or are rapidly traversing a highway, and cause the AV controls 1340 to be controlled accordingly. As another example, the computer processors 1328 learn to stop or slow down when the target object 1320 is a plastic bag or tumbleweed crossing the street in which the AV 1304 is traversing. The computer processors 1328 learn to come to a more aggressive stop when the target object 1320 is a baby carriage crossing the street, as compared to when the target object 1320 is a tumbleweed, and/or learn to speed up if, in a particular circumstance, speeding up will more likely allow for avoiding the baby carriage. In an embodiment, the computer processors 1328 learn to drive over certain target objects 1320 when driving over the target object 1320 is unlikely to cause damage to the AV 1304. For example, the computer processors 1328 distinguish plastic bags/tumbleweeds from large boulders (e.g., based on shape, size, motion, deformability, etc.) and cause the AV 1304 to drive over the plastic bags/tumbleweeds.

In an embodiment, the predicted speed is based at least partially on the received sensor information, historical sensor information, historical speed data of the AV 1304, current position data associated with the AV 1304, position data of at least one target object 1320, and/or traffic light data. For example, the computer processors 1328 determine that the AV 1304 should be travelling at a faster speed, relative to its current speed, based on speed limit information or detected traffic light information, and cause the AV controls 1340 to be controlled to increase the speed of the AV 1304. The computer processors 1328 determine that the AV 1304 should be travelling at a faster speed, relative to its current speed, when the AV 1304 is traversing a highway that has been previously traversed and the historical speed records associated with the AV 1304 indicates that the AV 1304 typically moves at faster speeds on the particular highway.

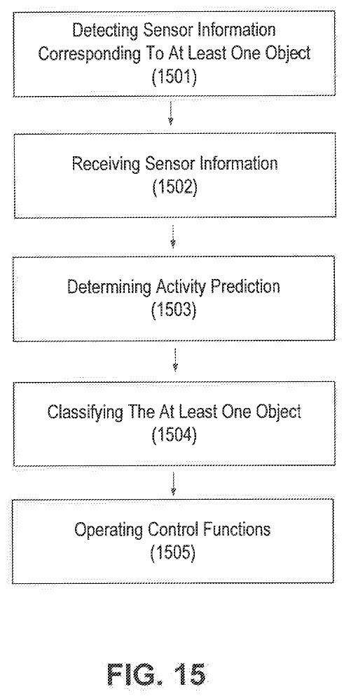

FIG. 15 shows a method 1500 for classifying perceived objects based on activity, according to one or more embodiments of the present disclosure. For illustrative purposes, the method 1500 is described as being performed by the system 1300 for classifying perceived objects based on activity. However, the method 1500 can be performed by other systems 1300 capable of perceiving and classifying objects. The method 1500 includes detecting sensor information corresponding to at least one object (block 1501), receiving sensor information (block 1502), determining an activity prediction (block 1503), classifying the at least one object (block 1504), and operating control functions (block 1505).

At block 1501, the sensors 1348 detect sensor information associated with the environment proximate to the AV 1304. The sensor information can include object detection, speed, and/or location data (e.g., location of vehicles, pedestrians, traffic lights, traffic signs, road/lane markings, etc.) of target objects 1320 proximate to the AV 1304. As indicated earlier, a target object 1320 can be, for example, a vehicle (e.g., car, scooter, bicycle, etc.), pedestrian, road fixture, and so forth.

At block 1502, the computer processors 1328 receive the captured sensor information from the sensors 1348.

At block 1503, the computer processors 1328 determine an activity prediction for at least one target object 1320 proximate to the AV 1304 in accordance with the received sensor information. For example, the computer processors 1328 determine a likelihood that a target vehicle proximate to the AV 1304 will be stationary for a certain period of time (e.g., for 10 seconds, 30 seconds, 1 minute, etc.). In an embodiment, determining an activity prediction includes determining one or more attribute associated with a target object 1320 proximate to the AV 1304. For example, the computer processors 1328 determine, based on the received sensor information, the road lane in which a target vehicle is located, a target vehicle's distance to a stop light/sign, a target vehicle's distance to a designated car park, the amount of free space in front of target object, the speed limit of the area in which a target vehicle is operating, and so forth.

In an embodiment, the computer processors 1328 assign one or more weights to the determined attributes of the detected target objects 1320. For example, when the computer processors 1328 include a Bayesian model machine learning processor, the computer processors 1328 assign weights to certain features, such as the lane in which a target vehicle is operating, whether or not a target vehicle's doors are open/closed, whether or not a target vehicle's engine is running, and so forth. The assigned weights can be based on learning which particular factors tend to have a heavier influence, when compared to the other factors, on predicting whether or not a target object 1320 is likely to be stationary (or to continue moving) for a certain time period. For instance, the computer processors 1328 may learn, through one or more machine learning techniques discussed previously, that a target vehicle's engine being turned off is more indicative that the target vehicle will remain stationary for a certain period of time than the object being in a parking lane, and the computer processors 1328 can assign weights to each attribute accordingly (e.g., higher weight values for the fact that the target vehicle's engine is not running). In an embodiment, the weights are used to produce a prediction value (e.g., prediction score) associated with the likelihood that a target object 1320 will remain stationary and/or in motion. In an embodiment, the manner in which the computer processors 1328 assign the weights are continuously updated based on, for instance, feedback information. The computer processors 1328 or a human operator can determine, based on the resulting output (e.g., inferences), whether the output exceeds an error threshold and, if the output does exceed an error threshold, update (e.g., adjust) the weighting scheme accordingly. For example, if the computer processors 1328, based on the received sensor information and the weighting scheme, predict that a target object 1320 will remain stationary for 30 seconds, and the target object 1320 actually remains stationary for only 10 seconds, the computer processors 1328 determine an error of 20 seconds. If 20 seconds exceeds the error threshold (e.g., 15 seconds), the weighting scheme used to determine the predicted activity can be updated in a manner to reduce the associated error.

At block 1504, the computer processors 1328 classify the at least one target object 1320 proximate to the AV 1304 in accordance with the activity prediction. In an embodiment, classifying a target object 1320 includes determining the likelihood that the object 1320 is inactive or active. Based on the amount of time an object 1320 is predicted to remain stationary or remain mobile (e.g., predicted activity), the computer processors 1328 determine if the object 1320 is active or inactive.

For example, if the received sensor information indicates that a target vehicle is moving forward and its engine is running, the computer processors 1328 can determine that the target vehicle will remain in motion for at least 30 additional seconds, and based on that determination, the computer processors 1328 classify the target vehicle as active. If the received sensor information indicates that a target vehicle is stationary with its engine not running, and that there are no passengers in the target vehicle, the computer processors 1328 can determine that the target car will remain stationary for at least 30 additional seconds, and based on this determination, can classify the target vehicle as inactive. If the sensor information indicates that a target vehicle is stationary, but has its engine running, an activated turn signal indicating that the target vehicle may be pulling into traffic, and that a driver is within the target vehicle looking over their shoulder, the computer processors 1328 determine that the target vehicle will not remain stationary for at least 30 additional seconds, and based on that determination, classify the target vehicle as active. Other factors that may lead to determining that a target object 1320 is active (e.g., will remain in motion for a certain period of time or will not remain stationary for a certain period of time) can include whether the sensor information indicates that a target vehicle is stopped in front of a stop light, whether the sensor information indicates that a target vehicle is onboarding passengers, whether the sensor information indicates that a target vehicle is traversing a highway, whether the sensor information indicates that a target vehicle is operating in dense traffic conditions, whether the sensor information indicates that a target object 1320 is a stationary road fixture (e.g., fire hydrant, street lamp, etc.), whether the sensor information indicates that a target object 1320 is a pedestrian entering a crosswalk, and so forth. The predetermined time interval may be a user/manufacturer choice or can be learned by the computer processors 1328 (e.g., using one or more machine learning techniques) and can be based on, for example, safety, efficiency and practical considerations.

In an embodiment, classifying a target object 1320 includes assigning an overtake value to the target object 1320. For example, the computer processors 1328 produce a score relating to whether the AV 1304 should pass the target object (e.g., by increasing the speed of the AV 1304 and maneuvering the AV 1304 around the target object 1320). The overtake value can be associated with the weighting scheme, as discussed previously, for determining the likelihood that a target object 1320 will remain static or in motion (e.g., based on engine heat values, presence of passengers/drivers, driver body position, distance to stop lights, etc.).

In an embodiment, the computer processors 1328 receive historical sensor information from, for example, the data storage 1364 and/or the server 1312, and based on the historical sensor information, in addition to the received current sensor information, determine that a target object 1320 is active/inactive. For example, at a previous point in time, the AV 1304 may have passed a target vehicle determined to be parked and inactive. Upon reaching the same location, if the received current sensor information indicates that the target vehicle is stationary at the same parked location, the computer processors 1328 can determine that the target vehicle is inactive based on the current sensor formation and the stored historical sensor information.

In an embodiment, the computer processors 1328 generate an uncertainty value corresponding to the classification of the at least one target object 1320. The uncertainty value can be assigned in accordance with the weighting scheme discussed previously and/or historical data such as data associated with the accuracy of past predictions. For example, the computer processors 1328 can assign higher uncertainty values to classifications associated with target objects 1320 that have been classified as active with a lower prediction score (based on the weighting scheme) than target objects 1320 that have been classified as active with a higher prediction score. As previously indicated, the weighting scheme can be based on determinations of the accuracy of previous classifications, and thus the uncertainty values can also be based on the accuracy of previous classifications.

At block 1505, the computer processors 1328 are configured to cause the control module 1336 (e.g., the controller circuit) to operate the AV controls 1340 (e.g., control functions) of the AV 1304 at least partially based on the classification of the at least one target object 1320. For example, in an embodiment, the control module 1336 operates the AV controls 1340 in such a manner to cause the AV 1304 to overtake a target object 1320 when the computer processors 1328 classify the target object 1320 as inactive. In an embodiment, the control module 1336 operates the AV controls 1340 at least partially based on at least one road rule. For example, the computer processors 1328 can cause the control module 1336 to operate the AV controls 1340 in accordance with laws regarding speed limits, lane violations, traffic light violations, and so forth. In an embodiment, the control module 1336 operates the AV controls 1340 in a manner to cause the AV 1304 to change its route of traverse. For example, if the AV 1304 is traversing a first route (e.g., a primary route) and the computer processors 1328 determine that a significant number of target objects 1320 are inactive (e.g., 5, 10, 20, etc.), the computer processors 1328 can cause the control module 1336 to operate the AV controls 1340 such that the AV 1304 traverses a second route (e.g., an alternate route).

In an embodiment, the control module 1336 operates the AV controls 1340 to cause the AV 1304 to approach a target object 1320 at a predetermined speed. For example, the predetermined speed is decreased speed relative to posted speed limits. In an embodiment, the control module 1336 operates the AV controls 1340 to cause the AV 1304 to maintain a predetermine distance from a target object 1320. For example, the predetermined distance is an increased distance relative to recommended following distances. The predetermined speed and/or distance can be based on the uncertainty value associated with the classification of a target object 1320. For example, if the uncertainty value exceeds an uncertainty value threshold (e.g., 30% uncertain), the AV 1304 can be caused to maintain a larger distance and a slower speed than when the target object's 1320 classification is associated with a lower uncertainty value (e.g., 20% uncertain).

In an embodiment, the control module 1336 operates the AV controls 1340 to cause the AV 1304 to either stop or slow down when an uncertainty value associated with a classification of a target object meets an uncertainty value threshold. In an embodiment, when the AV 1304 is either caused to stop or slow down, the computer processors 1328 cause the sensors 1348 to capture additional sensor information corresponding to the target object. For example, assume that a target object 1320 has been assigned a classification with an uncertainty value of 30% or higher. If the uncertainty value threshold is 29%, the uncertainty value assigned to the classification can be determined to meet the uncertainty value threshold, and the AV 1304 can be caused to stop or approach the target object at a predetermined speed (e.g., 5 mph, 10 mph, etc.) so that the sensors 1348 capture additional sensor information associated with the target object 1320 (e.g., amount of time the target object is remaining stationary, number of passengers in a target vehicle, changing heat values associated with a target car's engine, etc.). The additional sensor information can be used to adjust the assigned classification or the uncertainty value corresponding to the assigned classification.

In an embodiment, the control module 1336 operates the AV controls 1340 such that the AV 1304 is caused to travel at a predicted speed. In an embodiment, the predicted speed is based at least partially on learned human-like behavior. For example, the computer processors 1328 use the sensors 1348 to observe a human driver navigating an environment (either in the AV 1304 or another vehicle) and learn, through one or more machine learning techniques (e.g., deep learning), to replicate the observed behavior in terms of predicting the speed at which the AV 1304 should travel in a given situation. The computer processors 1328 access driving logs associated with a human driver (e.g., from the data storage 1364 and/or the server 1312), which can include video associated with the human driver's actions and/or historical speed data associated with the human driver's actions. Based on the observations and/or driving logs, the computer processors 1328 learn to replicate the actions taken by a human driver when encountering similar situations as the human driver. Thus, the computer processors 1328 can learn, for example, to overtake (e.g., pass) parked/inactive target objects 1320 more aggressively than target objects 1320 that may pull into traffic or are rapidly traversing a highway, and cause the AV controls 1340 to be controlled accordingly. As another example, the computer processors 1328 can learn to stop or slow down when the target object 1320 is a plastic bag or tumbleweed crossing the street in which the AV 1304 is traversing. The computer processors 1328 can also learn to come to a more aggressive stop when the target object 1320 is a baby carriage crossing the street, as compared to when the target object 1320 is a tumbleweed, and/or learn to speed up if, in a particular circumstance, speeding up will more likely allow for avoiding the baby carriage.

In an embodiment, the predicted speed is based at least partially on the received sensor information, historical sensor information, historical speed data of the AV 1304, current position data associated with the AV 1304, position data of at least one target object 1320, and/or traffic light data. For example, the computer processors 1328 can determine that the AV 1304 should be travelling at a faster speed, relative to its current speed, based on speed limit information or detected traffic light information, and cause the AV controls 1340 to be controlled to increase the speed of the AV 1304. The computer processors 1328 can determine that the AV 1304 should be travelling at a faster speed, relative to its current speed, when the AV 1304 is traversing a highway that has been previously traversed and the historical speed records associated with the AV 1304 indicates that the AV 1304 typically moves at faster speeds on the particular highway.

### Additional Embodiments

In an embodiment, operating the control functions of the vehicle includes causing the vehicle to approach the at least one object at a predetermined speed.

In an embodiment, operating the control functions of the vehicle includes causing the vehicle to maintain a predetermined distance from the at least one object.

In an embodiment, when the vehicle is traversing a primary route, operating the control functions of the vehicle includes causing the vehicle to traverse an alternate route.

In an embodiment, classifying the at least one object includes determining whether the at least one object has a running engine based on at least one audiovisual cue.

In an embodiment, at least one sensor detects sensor information corresponding to at least one object proximate to a vehicle. The sensor information is received from the at least one sensor. An activity prediction is determined for the at least one object in accordance with the sensor information. The at least one object is classified in accordance with the activity prediction. Control functions of the vehicle are operated at least partially based on the classification of the at least one object.

In an embodiment, the vehicle includes at least one sensor configured to receive sensor information corresponding to at least one object proximate to the vehicle. At least one controller circuit is configured to operate control functions of the vehicle. A computer-readable medium stores computer-executable instructions. At least one processor is communicatively coupled to the at least one sensor and configured to execute the computer-executable instructions to receive the sensor information from the at least one sensor. An activity prediction is determined for the at least one object in accordance with the sensor information. The at least one object is classified in accordance with the activity prediction as one of active or inactive. In accordance with a classification that the at least one object is inactive, the controller circuit is caused to operate the control functions of the vehicle to pass the at least one object.

In an embodiment, the at least one processor includes a Bayesian model processor.

In an embodiment, the at least one processor includes a deep learning processor.

In an embodiment, the deep learning processor includes at least one of: a feed-forward neural network, a convolutional neural network, a radial basis function neural network, a recurrent neural network, or a modular neural network.

In an embodiment, determining that the at least one object is active includes determining whether the at least one object will be in motion for a predetermined time interval.

In an embodiment, determining that the at least one object is inactive includes determining whether the at least one object will remain static for a predetermined time interval.

In an embodiment, the at least one processor is configured to determine one or more attributes of the at least one object based on the received sensor information. Classifying the at least one object is at least partially based on the determined one or more attributes.

In an embodiment, the one or more attributes include at least one of: a road lane in which the at least one object is located, a distance to a traffic sign of the at least one object, a distance to a designated parking space of the at least one object, or the speed of the at least one object.

In an embodiment, when the at least one processor is executing the computer-executable instructions, the at least one processor further carries out operations to: assign a weight to the determined one or more attributes of the at least one object and classifying the at least one object is at least partially based on the assigned weight.

In an embodiment, when the at least one processor is executing the computer-executable instructions, the at least one processor further carries out operations to continuously update the assigned weight based on feedback information.

In an embodiment, operating the control functions of the vehicle includes causing the vehicle to overtake the at least one object when the at least one processor classifies the at least one object as inactive.

In an embodiment, causing the controller circuit to operate the control functions of the vehicle is also at least partially based on at least one road rule.

In an embodiment, when the at least one processor is executing the computer-executable instructions, the at least one processor further carries out operations to generate an uncertainty value corresponding to the classifying of the at least one object.

In an embodiment, when the at least one processor is executing the computer-executable instructions, the at least one processor further carries out operations to cause the controller circuit to operate the control functions of the vehicle to cause the vehicle to at least one of: stop or slow down when the uncertainty value meets an uncertainty value threshold. The at least one sensor is caused to capture additional sensor information corresponding to the least one object.

In an embodiment, operating the control functions of the vehicle includes causing the vehicle to approach the at least one object at a predetermined speed.

In an embodiment, operating the control functions of the vehicle includes causing the vehicle to maintain a predetermined distance from the at least one object.

In an embodiment, when the vehicle is traversing a primary route, operating the control functions of the vehicle includes causing the vehicle to traverse an alternate route.

In an embodiment, classifying the at least one object includes determining whether the at least one object has a running engine based on at least one audiovisual cue.

In an embodiment, at least one sensor detects sensor information corresponding to at least one object proximate to a vehicle. The sensor information is received from the at least one sensor. An activity prediction is determined for the at least one object in accordance with the sensor information. The at least one object is classified in accordance with the activity prediction as one of active or inactive. Control functions of the vehicle are operated at least partially based on the classification that the at least one object is inactive.

In the foregoing description, embodiments of the invention have been described with reference to numerous specific details that may vary from implementation to implementation. The description and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

What is claimed is:

1. A vehicle, comprising:
at least one sensor configured to receive sensor information corresponding to at least one object proximate to the vehicle;
at least one controller circuit configured to operate control functions of the vehicle;
a computer-readable medium storing computer-executable instructions, and
at least one processor communicatively coupled to the at least one sensor and configured to execute the computer-executable instructions to:
receive the sensor information from the at least one sensor;
determine an activity prediction for the at least one object in accordance with the sensor information;
classify the at least one object in accordance with the activity prediction; and
cause the controller circuit to operate the control functions of the vehicle at least partially based on the classification of the at least one object.

2. The vehicle of claim 1, wherein the at least one processor comprises a Bayesian model processor.

3. The vehicle of claim 1, wherein the at least one processor comprises a deep learning processor.

4. The vehicle of claim 3, wherein the deep learning processor comprises at least one of: a feed-forward neural network, a convolutional neural network, a radial basis function neural network, a recurrent neural network, or a modular neural network.

5. The vehicle of claim 1, wherein classifying the at least one object includes determining the likelihood that the at least one object is inactive or active.

6. The vehicle of claim 5, wherein determining that the at least one object is active comprises determining whether the at least one object will be in motion for a predetermined time interval.

7. The vehicle of claim 5, wherein determining that the at least one object is inactive comprises determining whether the at least one object will remain static for a predetermined time interval.

8. The vehicle of claim 1, wherein operating the control functions of the vehicle comprises causing the vehicle to travel at a predicted speed, wherein the predicted speed is based at least partially on learned human-like behavior.

9. The vehicle of claim 1, wherein operating the control functions of the vehicle comprises causing the vehicle to travel at a predicted speed, wherein the predicted speed is based at least partially on at least one of: sensor data, historical speed data of the vehicle, position data of the vehicle, current position data of the at least one object, historical position data of the at least one object and traffic light data.

10. The vehicle of claim 1, wherein classifying the at least one object comprises assigning an overtake value.

11. The vehicle of claim 1, wherein the at least one processor is configured to determine one or more attributes of the at least one object based on the received sensor information, and wherein causing the controller circuit to operate the control functions of the vehicle is at least partially based on the determined one or more attributes.

12. The vehicle of claim 11, wherein the one or more attributes comprise at least one of: a road lane in which the at least one object is located, a distance to a traffic sign of the at least one object, a distance to a designated parking space of the at least one object, or the speed of the at least one object.

13. The vehicle of claim 11, wherein when the at least one processor is executing the computer-executable instructions, the at least one processor further carries out operations to: assign a weight to the determined one or more attributes of the at least one object and causing the controller circuit to operate the control functions of the vehicle is at least partially based on the assigned weight.

14. The vehicle of claim 13, wherein when the at least one processor is executing the computer-executable instructions, the at least one processor further carries out operations to continuously update the assigned weight based on feedback information.

15. The vehicle of claim 1, wherein operating the control functions of the vehicle comprises causing the vehicle to overtake the at least one object when the at least one processor classifies the at least one object as inactive.

16. The vehicle of claim 15, wherein causing the controller circuit to operate the control functions of the vehicle is also at least partially based on at least one road rule.

17. The vehicle of any of claim 1, wherein when the at least one processor is executing the computer-executable instructions, the at least one processor further carries out operations to generate an uncertainty value corresponding to the classifying of the at least one object.

18. The vehicle of claim 17, when the at least one processor is executing the computer-executable instructions, the at least one processor further carries out operations to:
cause the controller circuit to operate the control functions of the vehicle to cause the vehicle to at least one of: stop or slow down when the uncertainty value meets an uncertainty value threshold, and
cause the at least one sensor to capture additional sensor information corresponding to the least one object.

19. A method, comprising:
receiving, by at least one sensor of a vehicle, sensor information corresponding to at least one object proximate to the vehicle;
operating, by at least one controller circuit of the vehicle, control functions of the vehicle;
receiving, by one or more processors of the vehicle, the sensor information from the at least one sensor;
determining, by the one or more processors, an activity prediction for the at least one object in accordance with the sensor information;
classifying, by the one or more processors, the at least one object in accordance with the activity prediction; and
causing, by the one or more processors, the controller circuit to operate the control functions of the vehicle at least partially based on the classification of the at least one object.

20. A computer readable storage medium storing instructions executable by one or more processors, the instructions when executed by the one or more processors causing the one or more processors to:
receive, by at least one sensor of a vehicle, sensor information corresponding to at least one object proximate to the vehicle;
operate, by at least one controller circuit of the vehicle, control functions of the vehicle;
receive the sensor information from the at least one sensor;
determine an activity prediction for the at least one object in accordance with the sensor information;
classify the at least one object in accordance with the activity prediction; and
cause the controller circuit to operate the control functions of the vehicle at least partially based on the classification of the at least one object.
